(19) United States
(12) Patent Application Publication
(10) Pub. No.: US 2003/0231076 A1
(43) Pub. Date: Dec. 18, 2003

(54) Structure of non-reciprocal circuit element

(75) Inventors: Takayuki Takeuchi, Osaka (JP); Yasuhiko Horio, Osaka (JP); Osamu Inoue, Osaka (JP)

Correspondence Address: McDERMOTT, WILL & EMERY, 600 13th Street, N.W., Washington, DC, 20005-3096, US

(73) Assignee: Matsushita Electric Industrial Co., Ltd.

(21) Appl. No.: 10/449,235

(22) Filed: Jun. 2, 2003

(30) Foreign Application Priority Data
Jun. 3, 2002 (JP) P2002-161367

(51) Int. Cl. H01P 1/32

(52) U.S. Cl. 333/1.1; 333/24.2

(57) ABSTRACT

A non-reciprocal circuit element according to the present invention comprises at least three center electrodes which are superposed and arranged so as to intersect with each other. A capacitor connected to one end of the center electrodes in parallel is provided. Earth electrodes connected to the other ends of the center electrodes and arranged between center electrodes at least one by one are provided. The electrical isolation layers arranged between the center electrodes and the earth electrodes, respectively are provided. A ferrite member arranged adjacent to the center electrodes is provided. A magnet for applying a direct current magnetic field to the ferrite member is provided. A yoke material combined with the ferrite member and the magnet to constitute a magnetic circuit is provided. According to the present invention, since the earth electrodes are provided between the center electrodes at least one by one and the electrical isolation layers are provided between the center electrodes and the earth electrodes, respectively, miniaturization and mass production can be implemented without deteriorating electric properties.

### FIELD OF THE INVENTION

The present invention relates to a non-reciprocal circuit element which gives a direction to transmission of signals using a magnetic substance and a communication circuit module provided with the same as a circuit element.

### BACKGROUND OF THE INVENTION

As for a non-reciprocal circuit element such as a circulator or an isolator, which is used as a front-end part connected to an antenna of a mobile communication device, miniaturization, reduction in thickness and improvement of electric properties have been demanded increasingly. Especially, there is a strict demand for improvement of an insertion loss characteristic, which affects a battery life in a terminal. Thus, various kinds of steps have been taken to satisfy the above demands.

FIG. 27 is an exploded perspective view showing a conventional circulator 1. The conventional circulator 1 comprises a discoid ferrite member 2, a magnet 3, a parallel flat-plate capacitor 6a, 6b and 6c, an input-output terminal part 7, and yoke materials 4 and 8. The magnet 3 is disposed so as to be opposed to the ferrite member 2. The parallel flat-plate capacitor 6a, 6b and 6c constitutes a capacitor for matching. The input-output terminal part 7 has an input-output terminals 7a, 7b and 7c connected to outer circuits (not shown) The yoke materials 4 and 8 house the ferrite member 2, the magnet 3 and the like to constitute a magnetic circuit.

Although the yoke materials 4 and 8 are engaged with each other to be integrated, FIG. 27 is the exploded view of the yoke materials 4 and 8. Three center electrodes 5a, 5b and 5c are arranged around the ferrite member 2. The center electrodes 5a to 5c are formed of an electro conductive thin plate material. The center electrodes 5a to 5c are electrically insulated with each other and superposed so as to intersect with each other at an angle of 120 degrees.

FIG. 28 illustrates structures of the center electrodes 5a to 5c and the ferrite member 2. An insulating layer 9a is disposed between the center electrode 5a and the center electrode 5b and an insulating layer 9b is disposed between the center electrode 5b and the center electrode 5c. Respective one end of the center electrodes 5a to 5c are connected to a circular earth plate 5b disposed on the lower side of the ferrite member 2. The insulating layers 9a and 9b disposed between the center electrodes 5a to 5c are not shown in FIG. 27. The circular earth plate 5p is not shown in FIG. 30 because it is provided on the lower surface of the ferrite member 2.

The whole structure will be described again. Referring to FIG. 27, the lower electrodes of the three parallel flat-plate capacitors 6a, 6b and 6c are disposed at predetermined positions in the yoke material and connected to the yoke material 8. The center electrodes 5a to 5c are, on other end, connected to the upper electrodes of the parallel flat-plate capacitors 6a to 6c. The circular earth plate 5p in the ferrite member 2 on the side of the yoke material 8 is connected to a predetermined position on the yoke material 8. The yoke materials 8 comprises earth terminals 8d, 8e and 8f. The earth terminals 8d, 8e and 8f are connected to outer circuits (not shown) so as to input or output signals. A hole H for housing the ferrite member 2 is formed in the input-output terminal part 7. The input-output terminals 7a to 7c are formed in a resin structure body by insert molding. Three electrodes extended from the input-output terminals 7a to 7c on the lower surface of the input-output terminal part 7 are connected to respective ends of the center electrodes 5a to 5c connected on the parallel flat-plate capacitors 6a to 6c. Although the input-output terminal 7c is not shown in FIG. 27 because it is positioned at a hidden position, the input-output terminal 7c is disposed between the earth electrodes 8e and 8f.

Parts correspond to each other according to alphabets attached to reference numerals allotted to the parts in the figure.

In FIG. 27, the structure of the circulator was described. However, an isolator is configured by ending one of the input-output terminals with a resistor in the structure of the circulator.

The above is the basic structure of the conventional non-reciprocal circuit element. In order to improve miniaturization and mass production property of one layer of the non-reciprocal circuit element, a structure in which the center electrode part or a capacitor part or both are combined in one substrate has been proposed in recent technique trend. More specifically, there have been proposed various kinds of structures in which the center electrode part or the capacitor part or both are combined in one substrate by disposing electrodes three-dimensionally using a multilayer technique.

FIG. 29 illustrates a structure in which the center electrode part is integrated by a multilayer substrate. An essential structure of the multilayer substrate is shown in FIG. 30. The basic structure in FIG. 29 is the same as that of the circulator described in FIG. 27. Referring to a multilayer substrate 265 shown in FIG. 30, center electrodes 275a, 275b and 275c are layered through insulating layers. The center electrodes 275a to 275c are disposed so as to intersect with each other at an angle of 120 degrees. Terminal electrodes 271a, 271b, 271c, 271d, 271e and 271f for internal connections are disposed on the lower surface of the multilayer substrate 265. These terminal electrodes 271a to 271f are connected to the ends of the center electrodes 275a to 275c through via hole conductors. In FIG. 30, a connection state of each electrode through the via hole conductor is conceptually represented by broken lines. In addition, referring to FIG. 29, the terminal electrodes 271a to 271f for internal connections formed on the lower surface of the multilayer substrate 265 are connected to electrodes 266a, 266b, 266c, 266d, 266e and 266f formed on the upper surface of the input-output terminal part 267, respectively. The electrodes 266a to 266c are extended to the lower surface of the input-output terminal part 267 and connected to upper electrodes of the parallel flat-plate capacitors 6a to 6c. The electrodes 266a to 266c are further extended to be connected to the input-output terminals 267a to 267c. The input-output terminal 267c is not shown in FIG. 29. The electrodes 266d to 266f are extended to the lower surface of the input-output terminal part 267 to be connected to the yoke material 8. Parts correspond to each other according to alphabets attached to reference numerals allotted to the parts in the figure.

FIG. 31 illustrates a structure in which center electrodes and a capacitor part are integrated using the multilayer substrate. The essential part of the multilayer substrate is shown in FIG. 32. The basic structure in FIG. 31 is the same as that of the circulator described in FIG. 27. Referring to a multilayer substrate 285 shown in FIG. 32, center electrodes 295a, 295b and 295c are layered through insulating layers. The center electrodes 295a, 295b and 295c are disposed such that their longitudinal parts intersect with each other at an angle of 120 degrees in a plan view. Electrodes 296a, 296b and 296c are formed so as to be opposed to an earth electrode 292. Terminal electrodes 291a, 291b, 291c, 291d, 291e and 291f for internal connections are disposed on the lower surface of the multilayer substrate 285. The center electrodes 295a to 295c are, at one end, connected to the electrodes 296a to 296c and the terminal electrodes 291a to 291c through via hole conductors. The center electrodes 295a to 295c are, at other ends, connected to the earth electrode 292 and the terminal electrodes 291d to 291f through the via hole conductors. Referring to FIG. 31, the terminal electrodes 291a to 291f formed on the lower surface of the multilayer substrate 285a reconnected to electrodes 286a, 286b, 286c, 286d, 286e and 286f formed on the upper surface of an input-output terminal part 287. The electrodes 286a to 286c are provided in the input-output terminal part 287. The electrodes 286a to 286c are connected to the input-output terminals 287a to 287c. The input-output terminal 287c is not shown. The electrodes 286d to 286f are extended to the lower surface of the input-output terminal part 287 to be connected to the yoke material 8. Parts correspond to each other according to alphabets attached to reference numerals allotted to the parts in the figure.

As described above, a communication circuit module element has been formed by integrating some circuit elements in a wireless circuit constituting a front-end part or the like while a single part represented by a non-reciprocal circuit element has been miniaturized. This results in reduction in the number of parts and saving space. More specifically, in a case where the communication circuit module comprising a non-reciprocal circuit element constituted as a single part is formed, the non-reciprocal circuit element is mounted on a substrate constituting the communication circuit module and then packaged.

According to the improved conventional circulator (using the multilayer substrate) shown in FIGS. 29 and 31, the number of parts is reduced and troublesome assembly is eliminated as compared with the circulator shown in FIG. 27. As a result, a mass production property is improved and miniaturization is implemented. However, as compared with a structure in which earth ends of the center electrodes formed of metal foil are extended to the lower surface of the ferrite member to be connected to a common circular earth plate, a potential equalization property of each center electrode at the earth end is not enough in the improved conventional circulator. Therefore, according to the improved conventional circulator, deterioration of the electric properties or a rise in earth impedance could occur.

Furthermore, when the communication circuit module provided with the non-reciprocal circuit element is formed, so long as the non-reciprocal circuit element is constituted as a single part, there is a limit of reduction in the occupied space on the substrate of the non-reciprocal circuit element, which prevents miniaturization of the communication circuit module. This is because it is necessary to mount the non-reciprocal circuit element on the communication circuit module at a distance from the parts disposed around it at the time of mounting.

Furthermore, in a case where a part generating heat such as a power amplifier is contained in the communication circuit module, since it is necessary to consider a heat release measure, there is a limit in material and structure of the multilayer substrate used as the main component. As a result, the degree of freedom of the circuit composition is lowered and its integration becomes difficult.

### SUMMARY OF THE INVENTION

According to an embodiment of the present invention, there is provided a non-reciprocal circuit element comprising at least three center electrodes superposed and arranged so as to intersect with each other; a capacitor connected to one end of the center electrodes in parallel; earth electrodes connected to the other end of the center electrodes and disposed between center electrodes at least one by one; electrical isolation layers arranged between the center electrodes and the earth electrodes; a ferrite member arranged adjacent to the center electrodes; a magnet for applying a direct current magnetic field to the ferrite member; and a yoke material combined with the ferrite member and the magnet to constitute a magnetic circuit.

According to the above structure, since one or more earth electrodes are formed between respective layers of the three center electrodes formed separately, there can be provided a non-reciprocal circuit element in which a potential equalization property of each center electrode on the earth side can be improved and electric properties are not deteriorated even if the center electrodes are formed using a multilayer substrate. In addition, there can be provided a non-reciprocal circuit element having small earth impedance.

Furthermore, according to another embodiment of the present invention, there is provided a non-reciprocal circuit element comprising at least three center electrodes superposed and arranged so as to intersect with each other; the electrical isolation layers disposed between the center electrodes; a capacitor connected to one end of the center electrodes in parallel; a ferrite member arranged adjacent to the center electrodes; a magnet for applying a direct current magnetic field to the ferrite member; a yoke material combined with the ferrite member and the magnet to constitute a magnetic circuit; a multilayer substrate comprising the center electrodes and the electrical isolation layer; and via hole conductors provided in the multilayer substrate and connecting layers at connection points in the multilayer substrate comprising connection points of both ends of the center electrodes. In addition, the via hole conductor connected to the other ends of the center electrodes has electric resistance lower than that of the another via hole conductors.

According to the above structure, since the electrode pattern of each layer in the multilayer substrate is connected by the via hole conductor, the non-reciprocal circuit element can be manufactured while the substrate is formed and its mass production property is considerably improved as compared with a case where a side electrode is separately formed. Furthermore, at this time, since the via hole conductor connected to the other ends of the center electrodes has electric resistance lower than that of other via hole conductors, there can be provided a non-reciprocal circuit element in which earth impedance is reduced and electric properties are excellent as compared with a case where uniform connections are made by via hole conductors having the same conductivity.

Furthermore, it is preferable that the via hole conductors connected to on one end of the center electrodes have a total sectional area larger than that of the via hole conductors connected to the other end of the center electrodes or the via hole conductors connected to other electrode patterns in the multilayer substrate.

According to the thus non-reciprocal circuit element, since the via hole conductor having electric resistance lower than that of the other via hole conductors can be formed with relative ease, its mass production property is considerably improved.

According to still another embodiment of the present invention, there is provided a non-reciprocal circuit element comprising at least three center electrodes superposed and arranged so as to intersect with each other; a capacitor connected to one end of the center electrodes in parallel; the electrical isolation layers arranged between the center electrodes, respectively; a ferrite member arranged adjacent to the center electrodes; a magnet for applying a direct current magnetic field to the ferrite member; a yoke material combined with the ferrite member and the magnet to constitute a magnetic circuit; a multilayer substrate comprising the center electrodes and the electrical isolation layers; and an earth electrode provided on the end surface of the multilayer substrate. Furthermore, the other ends of the center electrodes are extended to the end surface of the multilayer substrate to be connected to the earth electrode.

According to the above structure, since the other ends of the three center electrodes separately formed are connected to the earth electrode on the end surface of the multilayer substrate, there can be provided the non-reciprocal circuit element in which a potential equalization property of each center electrode on the earth side can be improved and electric properties are not deteriorated even if the center electrodes are formed using a multilayer substrate. In addition, there can be provided the non-reciprocal circuit element having small earth impedance.

In addition, it is preferable that the capacitor is formed in the multilayer substrate. Thus, the non-reciprocal circuit element can be further miniaturized.

According to still another embodiment of the present invention, there can be provided a non-reciprocal circuit element comprising at least three center electrodes superposed and arranged so as to intersect with each other; the electrical isolation layers arranged between the center electrodes; a capacitor connected to one end of the center electrodes in parallel; a ferrite member arranged adjacent to the center electrodes; a magnet for applying a direct current magnetic field to the ferrite member; a yoke material combined with the ferrite member and the magnet to constitute a magnetic circuit; and a multilayer substrate comprising the center electrodes and the electrical isolation layers. Still further, the capacitor comprises a pair of counter electrodes arranged on the opposite sides and a dielectric layer sandwiched between the counter electrodes and the capacitor is integrated with the multilayer substrate. One of the counter electrodes is connected to one end of the center electrode and the other counter electrode is exposed on a surface of the multilayer substrate.

According to the above structure, since the electrode of the capacitor on the earth side can be connected to the outer electrode at the earth potential by the shortest distance, earth impedance is reduced. In this case, since the capacitor is composed of a pair of counter electrodes and a dielectric layer, there can be provided a pure capacitive element which does not contain an unnecessary inductance component as compared with a case where the capacitor is formed by a multilayer structure using a plurality of counter electrodes. Thus, there can be provided the non-reciprocal circuit element having the excellent electric properties.

Furthermore, when the capacitor is layered in the multilayer substrate, it is preferable that the dielectric layer is made of a material having dielectric constant higher than that of the electrical isolation layer. Thus, even when the capacitor is formed by a single-layer structure, sufficient capacitive value can be obtained.

In addition, it is preferable that an earth electrode is provided between the layers of the multilayer substrate other than the dielectric layer and this earth electrode is connected to the other ends of the center electrodes. Thus, since there is provided the earth electrode connected to the other ends of the respective center electrodes, a potential equalization property of each center electrode on the earth side can be improved and there can be provided the non-reciprocal circuit element having the further excellent electric properties.

Furthermore, it is preferable to further comprise a surface electrode exposed on a surface of the multilayer substrate and connected to the other ends of the center electrodes and it is preferable that the yoke material is formed of an electroconductive material and the yoke material abuts on the surface electrode to be connected. Thus, by electrically connecting the earth electrode to the yoke material directly, earth impedance of the multilayer substrate can be lowered using low impedance of the yoke material. Consequently, there can be provided the non-reciprocal circuit element having favorable electric properties.

In addition, according to the communication module of the present invention, it is preferable that the multilayer substrate is the main component of the communication circuit module. Thus, since the non-reciprocal circuit element is comprised in the multilayer substrate serving as the main component of the communication circuit module, it becomes less necessary to consider the positional relation with the parts arranged around it. As a result, the non-reciprocal circuit element having excellent electric properties according to the present invention can be taken in the communication circuit module while the effective occupied space is reduced.

In addition, it is preferable that electrode patterns comprising the center electrodes are provided in the multilayer substrate and an electrode thickness of the center electrode is larger than an average value of an electrode thickness of the other electrode patterns provided in the multilayer substrate.

Thus, conductor resistance of the center electrodes at the non-reciprocal circuit element part can be lowered by an additional minimum step. As a result, transmission loss can be reduced and there can be easily provided the communication circuit module comprising the non-reciprocal circuit element having the excellent electric properties.

In addition, when the communication module is formed and parts are mounted on the multilayer substrate, it is preferable that at least one of the parts abuts on the yoke material. Thus, it becomes possible to effectively release the heat of a mounted part to the outside through the yoke material. As a result, highly effective heat releasing structure can be provided without using specific multilayer substrate material or multilayer structure. Consequently, there can be provided the communication circuit module in which the degree of freedom of the circuit structure is high and the degree of integration is also high.

Furthermore, in a case where the part generating heat is a power amplifier, since its heat releasing is very important, the effect according to the present invention is especially prominent.

Still further, in a case where the communication circuit is formed, it is preferable that a plurality of non-reciprocal circuit elements is provided. If so, even if the communication circuit module uses a plurality of frequency bands such as dual band, triple band or the like, it becomes less necessary to consider its positional relation with parts arranged around it. As a result, it becomes possible to take a plurality of non-reciprocal circuit elements in the communication circuit module while effective occupied space is reduced. Consequently, an integrated small multi-band communication circuit module can be provided.

Furthermore, it is preferable that the yoke materials are not separately prepared in the plurality of non-reciprocal circuit elements but a set of yoke materials is shared. Furthermore, it is preferable that a set of magnets is shared.

Thus, since the number of parts can be reduced, there can be provided the multi-band communication circuit module in which the plural circulators, which are excellent in view of mass production property and costs, are comprised.

In addition, it is preferable to provide a cavity for housing one part or all of the ferrite member and the yoke material in the multilayer substrate in such a manner that the surface of the members does not protrude from the multilayer substrate. Alternatively, it is preferable to provide a cavity for housing one part or all of the magnet and the yoke material in the multilayer substrate in such a manner that the surface of the members does not protrude from the multilayer substrate. Thus, since there is no projection which becomes a problem in mounting one surface of the communication circuit module, it can be easily mounted to a circuit substrate such as a mobile phone or the like.

According to the present invention described above, there can be provided the non-reciprocal circuit element which implements miniaturization and mass production without deteriorating the electric characteristic. In addition, there can be provided the communication circuit module provided with the non-reciprocal circuit element in which effective occupied space is reduced without deteriorating the electric characteristic. Furthermore, there can be provided the communication circuit in which heat generated by the mounted parts can be released by a simple method without being subjected to various restraints in the material or configuration of the multilayer substrate.

Furthermore, the electrical isolation layer, according to the present invention, can be composed of a layer such as an electrically insulating layer, a dielectric layer or the like. In addition, according to the present invention, a distance between the ferrite member and the center electrodes is such that both are adjacent. This distance is set such that magnetic influence generated by the magnetic circuit comprising the ferrite member can be fully accepted by the center electrodes.

### BRIEF DESCRIPTION OF THE DRAWINGS

The objects other than the those of the present invention will become more apparent from the following detailed description of the present invention and clear from the appended claims. Implementation of the present invention will remind those skilled in the art of many benefits which were not referred to in this specification.

FIG. 1 is an exploded perspective view showing a multilayer substrate constituting a circulator according to a first preferred embodiment of the present invention;

FIG. 2 is an exploded perspective view showing a multilayer substrate constituting a circulator according to a variation of the first preferred embodiment of the present invention;

FIG. 3 is an exploded perspective view showing a multilayer substrate constituting a circulator according to a first structure of a second preferred embodiment of the present invention;

FIG. 4 is an exploded perspective view showing a multilayer substrate constituting a circulator according to a second structure of the second preferred embodiment of the present invention;

FIG. 5 is an exploded perspective view showing a multilayer substrate constituting a circulator according to a first variation of the second preferred embodiment of the present invention;

FIG. 6 is an exploded perspective view showing a multilayer substrate constituting a circulator according to a second variation of the second preferred embodiment of the present invention;

FIG. 7 is an exploded perspective view showing a circulator according to a third preferred embodiment of the present invention;

FIG. 8 is a longitudinal sectional view showing the circulator according to the third preferred embodiment of the present invention;

FIG. 9 is an exploded perspective view showing a multilayer substrate constituting the circulator according to the third preferred embodiment of the present invention;

FIGS. 10A to 10C are plan views showing structures and positions of via hole conductors in a multilayer substrate according to variations of the first to third embodiment of the present invention;

FIG. 11 is an exploded perspective view showing a multilayer substrate constituting a circulator according to a fourth preferred embodiment of the present invention;

FIG. 12 is an exploded perspective view showing a circulator according to a fifth preferred embodiment of the present invention;

FIG. 13 is a longitudinal sectional view showing a circulator according to the fifth preferred embodiment of the present invention;

FIG. 14 is an exploded perspective view showing a multilayer substrate constituting a circulator according to the fifth preferred embodiment of the present invention;

FIG. 15 is an exploded perspective view showing a communication circuit module according to a sixth preferred embodiment of the present invention;

FIG. 16A is a sectional view showing a non-reciprocal circuit element part of a communication circuit module according to a first structure of the sixth preferred embodiment of the present invention;

FIG. 16B is a plan view showing the non-reciprocal circuit element part of the communication circuit module according to the first structure of the sixth preferred embodiment of the present invention;

FIG. 17 is a partially cutaway view in perspective showing a non-reciprocal circuit element part in a multilayer substrate of a communication circuit module according to a first structure of the sixth preferred embodiment of the present invention;

FIG. 18 is an exploded perspective view showing a communication circuit module according to second structure of a sixth preferred embodiment of the present invention;

FIG. 19A is a sectional view showing a non-reciprocal circuit element part of the communication circuit module according to the second structure of the sixth preferred embodiment of the present invention;

FIG. 19B is a plan view showing the non-reciprocal circuit element part of the communication circuit module according to the second structure of the sixth preferred embodiment of the present invention;

FIG. 20 is a partially cutaway view in perspective showing the non-reciprocal circuit element part in a multilayer substrate of the communication circuit module according to the second structure of the sixth preferred embodiment of the present invention;

FIG. 21 is a sectional view showing a multilayer substrate according to a first structure of a seventh preferred embodiment of the present invention;

FIG. 22 is a sectional view showing a multilayer substrate according to a second structure of the seventh preferred embodiment of the present invention;

FIG. 23 is an exploded perspective view showing a communication circuit module according to an eighth preferred embodiment of the present invention;

FIG. 24 is a sectional view showing the communication circuit module according to the eighth preferred embodiment of the present invention;

FIG. 25 is an exploded perspective view showing a communication circuit module according to a ninth preferred embodiment of the present invention;

FIG. 26 is a sectional view showing a non-reciprocal circuit element part of the communication circuit module according to the ninth preferred embodiment of the present invention;

FIG. 27 is an exploded perspective view showing a circulator according to a first conventional example;

FIG. 28 is an exploded perspective view showing a center electrode part of the circulator according to the first conventional example;

FIG. 29 is an exploded perspective view showing the circulator according to the first conventional example;

FIG. 30 is an exploded perspective view showing a multilayer substrate of the circulator according to the first conventional example;

FIG. 31 is an exploded perspective view showing the circulator according to the first conventional example; and

FIG. 32 is an exploded perspective view showing a multilayer substrate of a circulator according to a second conventional example.

### DETAILED DESCRIPTION OF THE INVENTION

Hereinafter, preferred embodiments of the present invention will be described with reference to the drawings.

(First Embodiment)

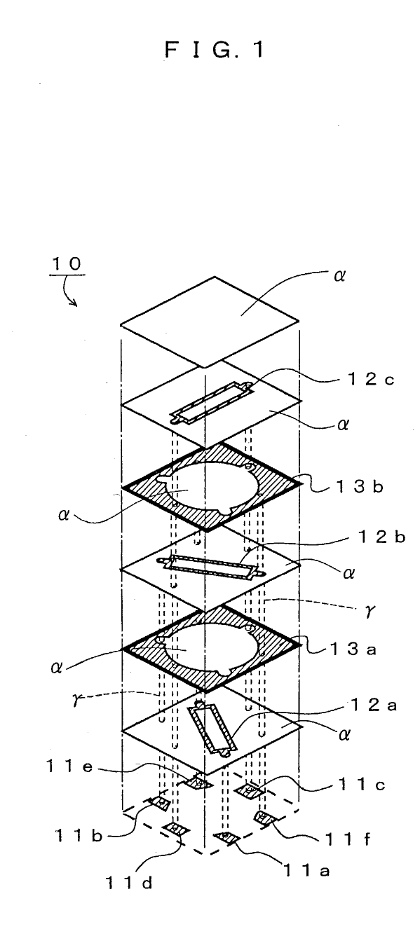

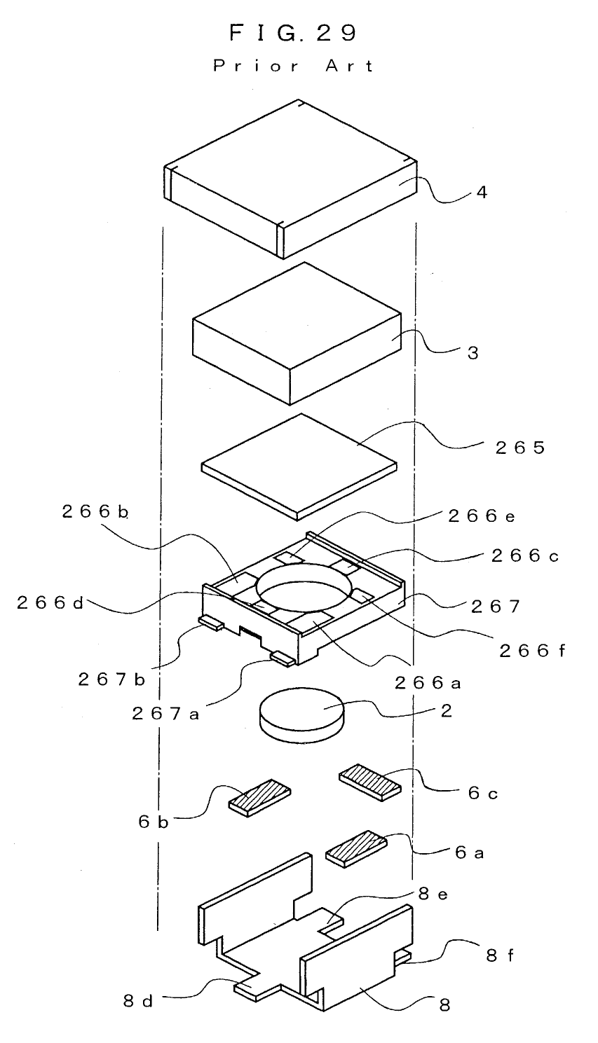

According to a first embodiment of the present invention, an example in which only a center electrode part is composed of a multilayer substrate will be described. FIG. 1 illustrates a structure of a multilayer substrate 10 of a circulator according to the first embodiment of the present invention. The structure of the whole circulator is such that a multilayer substrate 265 of a circulator shown in FIG. 29 is replaced with the multilayer substrate 10 shown in FIG. 1. Therefore, detailed description of the structure of the circulator according to this embodiment will be omitted.

Center electrodes 12a, 12b and 12c are elongated rectangular frame-shape in plan view. The center electrodes 12a to 12c are layered and arranged such that elongated parts in plan view intersect with each other at an angle of 120 degrees . Earth electrodes 13a and 13b are disposed between the center electrodes 12a to 12c, respectively. Insulating layers α serving as electrical isolation layers are provided between the earth electrodes 13a and 13b and the center electrodes 12a to 12c. Thus, the center electrodes 12a to 12c, the insulating layers α and earth electrodes 13a and 13b are laminated. The insulating layers α are disposed at both outer ends of the center electrodes 12a and 12c. As described above, the multilayer substrate 10 is provided.

Terminal electrodes 11a, 11b, 11c, 11d, 11e and 11f for internal connections are disposed on the lower surface of the multilayer substrate 10. One end of the center electrode 12a is connected to the terminal electrode 11a through a via hole conductor γ. One end of the central electrode 12b is connected to the terminal electrode 11b through a via hole conductor γ. One end of the center electrode 12c is connected to the terminal electrode 11c through the via hole conductor 7.

The other ends of the center electrodes 12a to 12c are connected to the earth electrodes 13a and 13b through the via hole conductors y. The other ends of the center electrodes 12a to 12c are also connected to the terminal electrodes 11d to 11f, respectively. In the figure, connection points through the via hole conductors γ are conceptually shown by thin broken lines.

According to the structure of the circulator of this embodiment of the present invention,

the earth electrodes 13a and 13b are disposed between the center electrodes 12a to 12c, and

one end of the center electrodes 12a to 12c is connected to the earth electrodes 13a and 13b. Thus, a potential equalization property of each of the center electrodes 12a to 12c on the earth side is improved and an insertion loss characteristic is also improved.

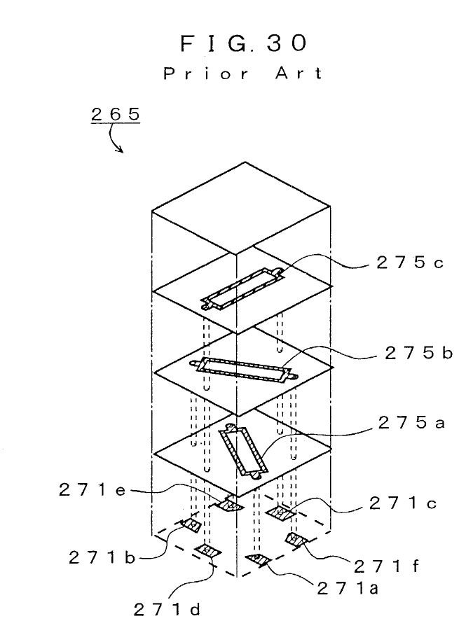

Measured results of the insertion loss characteristics of the circulator according to this embodiment and the conventional circulator comprising the multilayer substrate 265 shown in FIG. 30 are shown in table 1. The measurement was performed under the condition that the center frequency is 1.96 GHz and a device size of the circulator is 3 mm square.

TABLE 1

| | Insertion loss (dB) |
|---|---|
| Conventional example | 0.82 |
| First embodiment | 0.54 |

According to the circulator of this embodiment of the present invention, the potential equalization property of each of the center electrodes 12a to 12c on the earth side and the insertion loss characteristic is improved as compared to the conventional one.

In addition, although earth electrodes 13a and 13b are disposed between center electrodes 12a and 12b, and 12b and 12c, respectively, plurality of earth electrodes may be disposed between center electrodes 12a to 12c.

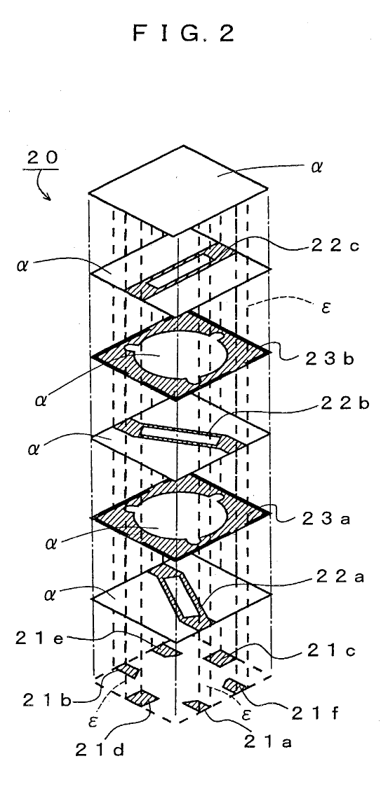

In addition, an electrode pattern and a position of each electrode shown in this embodiment is not limited to the above and any change is possible so long as it is within the scope of the present invention, where by the same effect can be obtained. For example, as shown in FIG. 2, instead of the via hole conductors γ, the electrode patterns of the layers may be connected to each other through an electrode pattern ε formed on the outer surface of the multilayer substrate 20.

Referring to FIG. 2, terminal electrodes 21a, 21b, 21c, 21d, 21e and 21f for internal connections are provided on the lower surface of the multilayer substrate 20. One end of the electrodes 21a to 21f is extended to an edge of the multilayer substrate 20. One end of the center electrodes 22a to 22c is connected to the electrodes 21a to 21c through the electrode patterns ε formed on the outer surface of the multilayer substrate 20. The other ends of the center electrodes 22a to 22c are connected to the earth electrodes 23a and 23b through the electrode patterns ε formed on the outer surface of the multilayer substrate 20. At the same time, the other ends of the center electrodes 22a to 22c are connected to the terminal electrodes 21d to 21f, respectively through the electrode pattern ε. In the figure, the connecting points by the electrode patterns ε are conceptually shown by broken lines.

(Second Embodiment)

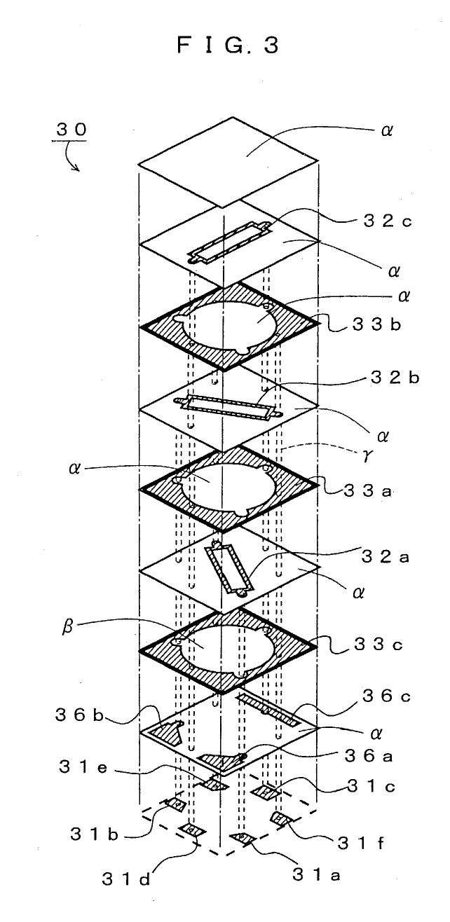

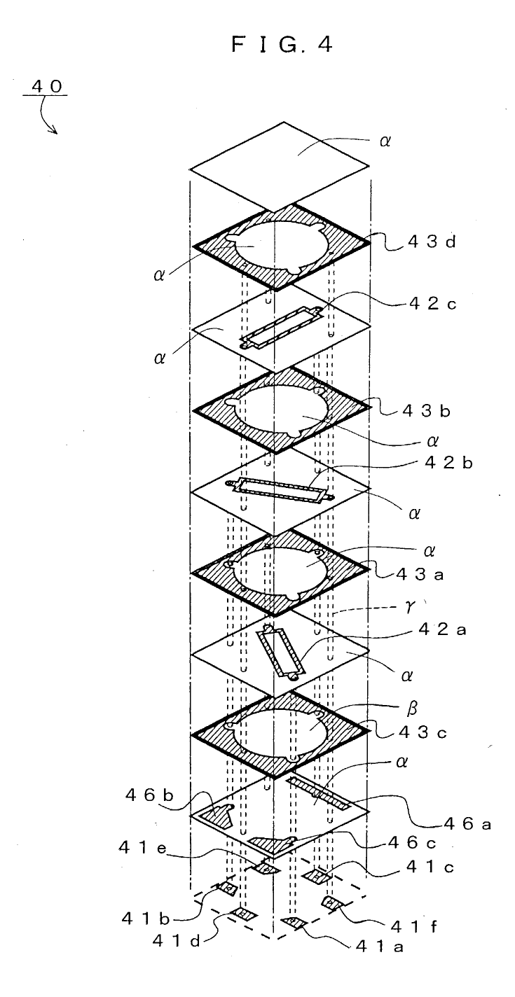

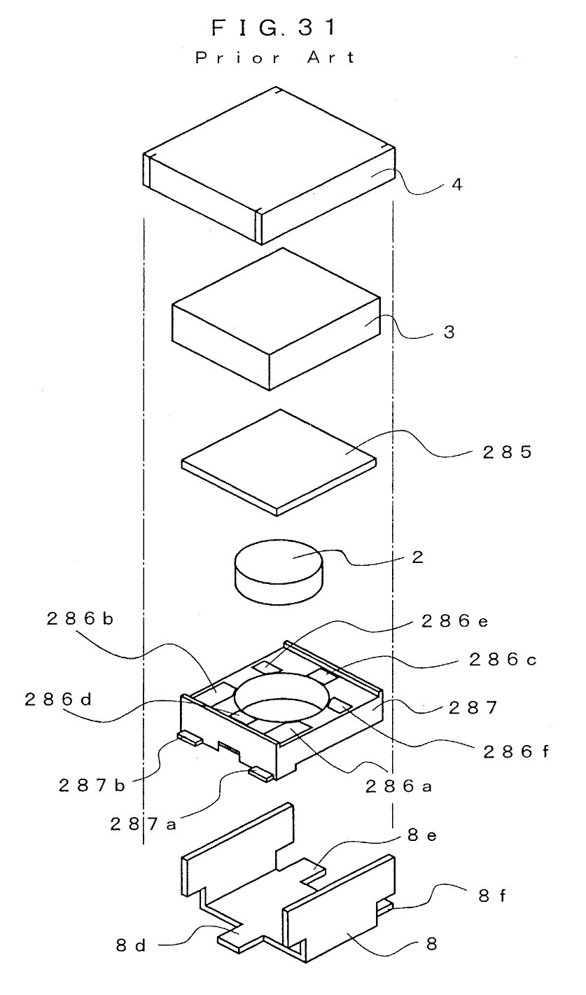

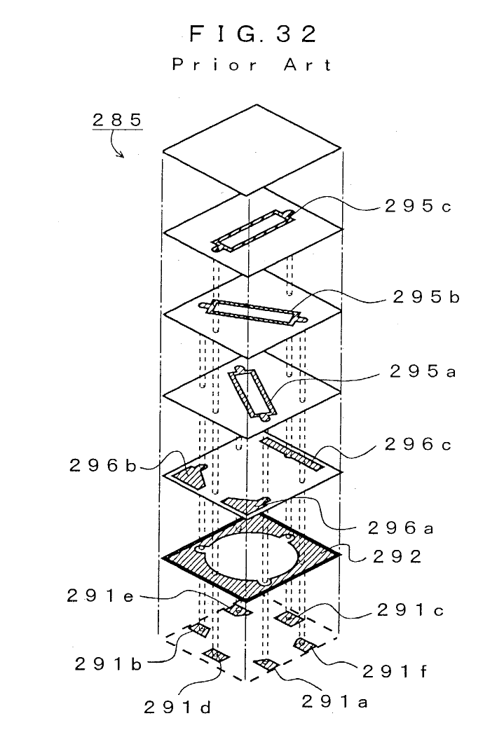

According to the second embodiment of the present invention, center electrodes and a capacitor part comprises a multilayer substrate. FIG. 3 illustrates a multilayer substrate 30 of a circulator, according to the first structure of the second embodiment of the present invention. FIG. 4 illustrates a structure of a multilayer substrate 40 of a circulator according to the second structure of the second embodiment of the present invention. The structure of the circulator is such that the multilayer substrate 285 of the circulator shown in FIG. 31 described in the conventional example is displaced with the multilayer substrate 30 shown in FIG. 3 or the multilayer substrate 40 of shown in FIG. 4. Therefore, detailed description of the whole circulator will be omitted.

The multilayer substrate 30, according to the first structure of this embodiment of the present invention, comprises center electrodes 32a, 32b and 32c, earth electrodes 33a and 33b, and terminal electrodes 31a, 31b, 31c, 31d, 31e and 31f for internal connections. The structures of the electrodes 32a to 32c, 33a, 33b, and 31a to 31f are basically the same as those of the center electrodes 12a to 12c, earth electrodes 13a and 13b, and terminal electrodes 11a to 11f in the first embodiment of the present invention. According to the multilayer substrate 30, an earth electrode 33c is provided outside of the center electrode 32a with the insulating layer α disposed therebetween. Counter electrodes 36a, 36b and 36c for forming a capacitor are provided between the earth electrode 33c and the terminal electrodes 31a to 31f. The counter electrodes 36a to 36c are opposed to the earth electrode 33c through a dielectric layer β. In this case, a capacitor is composed of the earth electrode 33c, the counter electrodes 36a to 36c and the dielectric layer β disposed between them.

One end of the center electrode 32a is connected to the electrode 36a and 31a through a via hole conductor γ. One end of the center electrode 32b is connected to the electrodes 36b and 31b through the via hole conductor γ. One end of the center electrode 32c is connected to the electrodes 36c and 31c through the via hole conductor γ.

Other ends of the center electrodes 32a to 32c are connected to the earth electrodes 33a to 33c through the via hole conductors γ. In addition, the center electrode 32a is, on one end, connected to electrode 31e through the via hole conductor γ. The center electrode 32b is, on the other end, connected to the electrode 31f through the via hole conductor γ. In the figure, the connecting points by the via hole conductors γ are conceptually shown by thin broken lines.

As shown in FIG. 4, the multilayer substrate 40, according to the second structure of this embodiment of the present invention, has basically the same structure as that of the multilayer substrate 30, according to the first structure. Then, in FIG. 4, the parts corresponding to the parts allotted by reference numerals in the 30s in the multilayer substrate 30 are allotted by reference numerals in the 40s and thus, reference numerals in single figure and alphabets allotted at the end of the numerals which are allotted to parts of the multilayer substrate 40 (FIG. 4) are common to those of the multilayer substrate 30 (FIG. 3).

The multilayer substrate 40 further comprises another earth electrode 43d. The earth electrode 43d is provided as an upper layer of the center electrode 43b which is the uppermost layer with the insulating layer α disposed therebetween. The earth electrode 43d is connected to other earth electrodes 43a to 43c through the via hole conductors γ. The earth electrode 43d is connected to the other ends of the center electrodes 42a to 42c through the via hole conductors γ. In the figure, connections through the via hole conductors y are conceptually shown by thin broken lines.

According to the circulator of this embodiment of the present invention,

the earth electrodes 33a, 33b, 43a and 43b are disposed between the center electrodes 32a to 32c, and 42a to 42c, respectively, and

one end of the center electrodes 32a to 32c and 42a to 42c is connected to the earth electrodes 33a to 33c, and 43a to 43d, respectively. Thus, potential equalization property of each of the via hole conductors electrodes 32a to 32c and 42a to 42c on the earth side is improved and the insertion loss characteristic is improved.

Measured results of the insertion loss characteristics of the circulator, according to this embodiment and the conventional circulator shown in FIG. 31, are shown in a table 2. The measurement was performed under the condition that the center frequency is 1.96 GHz and a device size of the circulator is 3 mm square.

TABLE 2

| | Insertion loss (dB) |
|---|---|
| Conventional example | 0.91 |
| First structure of | 0.65 |
| second embodiment | |
| Second structure of | 0.59 |
| second embodiment | |

According to the circulator of this embodiment of the present invention, the potential equalization property of each of the center electrodes 32a to 32c and 42a to 42c on the earth side and the insertion loss characteristic are improved. In addition, as shown in the multilayer substrate 40, in a case where the earth electrode 43d which is not a counter electrode for forming the capacitor is further provided between layers other than the layers in which the center electrodes 42a to 42c are formed, a further preferable effect can be obtained.

Furthermore, although each of the earth electrodes 33a to 33c and 43a to 43c is disposed between center electrodes 32a to 32c, and 42a to 42c, respectively, a plurality of earth electrodes may be disposed between center electrodes 32a to 32c and 42a to 42c.

In addition, a plurality of earth electrodes may be disposed between layers other than layers in which the center electrodes are formed and a plurality of earth electrodes may be disposed at a place other than the dielectric layer β in which a capacitor is formed.

An electrode pattern and a position of each electrode shown in this embodiment is not limited to the above and any change is possible so long as it is within the scope of the present invention, whereby the same effect can be obtained.

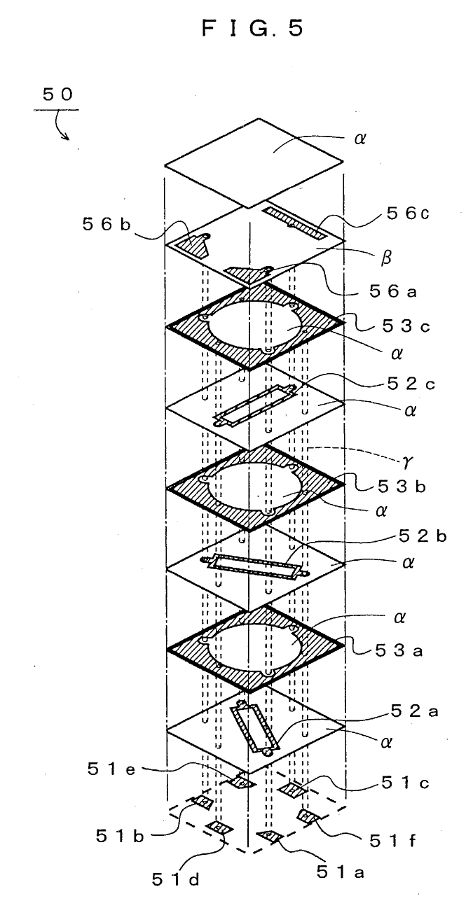

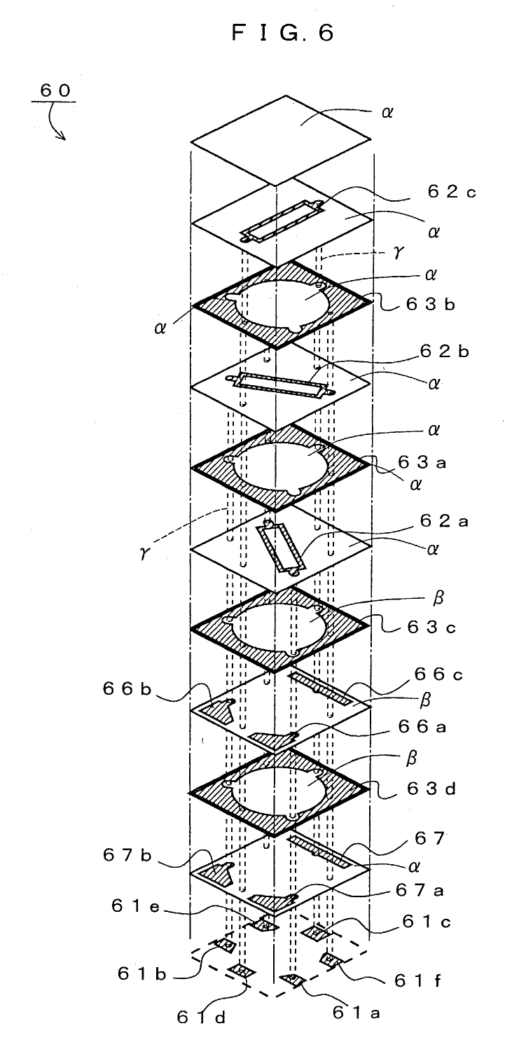

For example, as shown by the multilayer substrate 50 in FIG. 5, the counter electrodes 56a, 56b and 56c for forming the capacitor may be disposed above the center electrode 52c of the uppermost layer. In addition, as shown by the multilayer substrate 60 in FIG. 6, a plurality of sets of counter electrodes for forming the capacitor (two sets of counter electrodes 66a to 66c and 67a to 67c in FIG. 6) is provided and those counter electrodes are opposed to the earth electrodes 63c and 63d across the dielectric layer β in the thickness direction of the multilayer substrate 60. Thus, the capacitors may be formed.

More specifically, according to the multilayer substrate 60 shown in FIG. 6, the counter electrodes 66a to 66c and the earth electrode 63c form a first capacitor, the counter electrodes 66a to 66c and the earth electrode 63d form a second capacitor and the counter electrodes 67a to 67c and the earth electrode 63d form a third capacitor.

In addition, according to the multilayer substrate 60 shown in FIG. 6, although a large capacity can be formed, since the capacitors are layered, unnecessary inductance component could be generated at the capacitors. Therefore, if priority is given to suppression of the unnecessary inductance, it is preferable that the capacitor is of a single-layer structure as shown in FIGS. 3 to 5. However, in that structure, the capacitor capacity sometimes comes short depending on the center frequency and an element size of a non-reciprocal circuit element to be formed. In this case, the dielectric layer β disposed between layers in which the capacitor is formed is to be formed of a material having dielectric constant higher than electrical isolation layers (insulating layers) between other layers. Thus, sufficient capacity can be obtained.

(Third Embodiment)

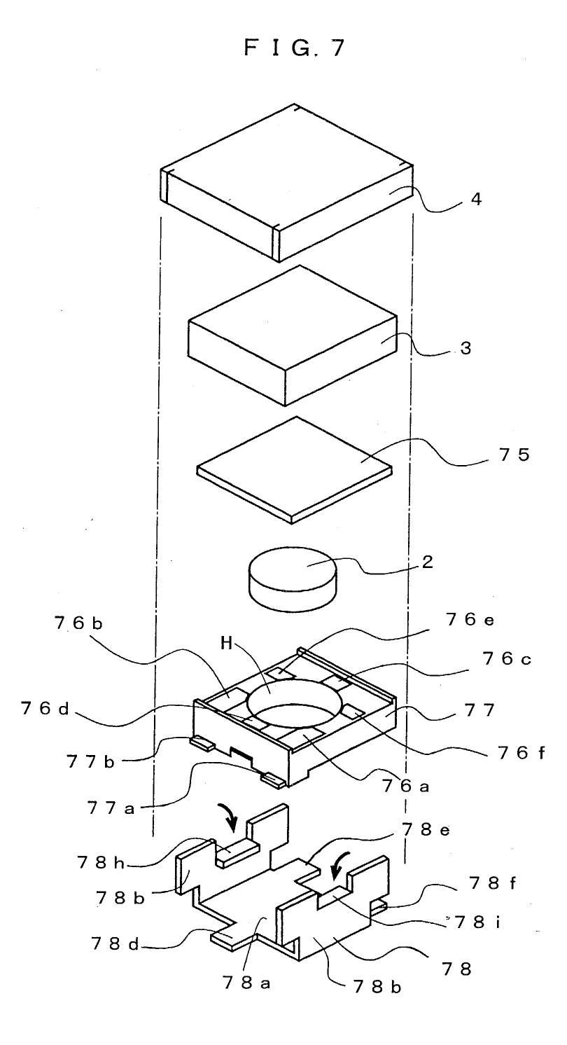

According to a third embodiment of the present invention, earth impedance in a multilayer substrate is reduced by using low impedance of a yoke material. A circulator, according to the third embodiment of the present invention, is shown in FIGS. 7 to 9.

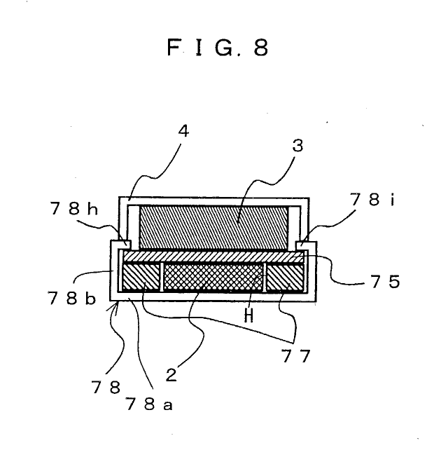

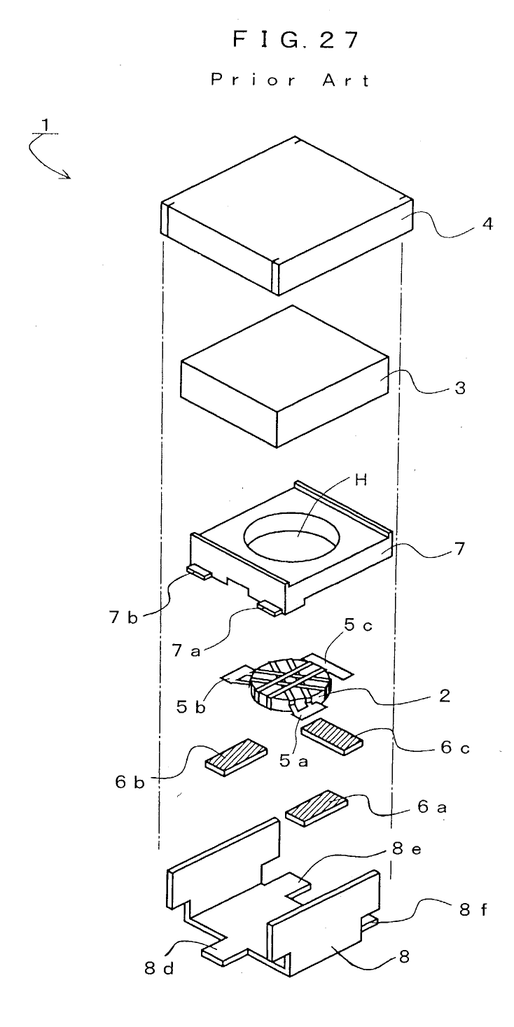

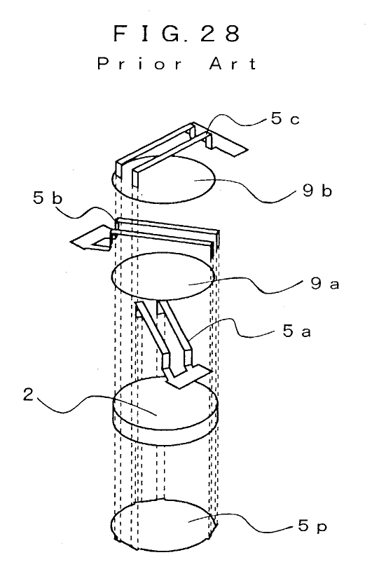

A structure of the circulator shown in FIG. 7 is basically the same as that of the circulator described in FIG. 27. FIG. 8 is a longitudinal sectional view of the circulator shown in FIG. 7.

An input-output terminal part 77 is housed in a yoke material 78. A circular hole H is formed in the center of the input-output terminal part 77. A circular ferrite member 2 is housed in the hole H. A multilayer substrate 75 is set on the input-output terminal part 77. A magnet 3 is set on the multilayer substrate 75. In this state, a yoke material 4 is mounted on the yoke material 78. The input-output terminal part 77, the ferrite member 2, the multilayer substrate 75 and the magnet 3 are housed inside the integrated yoke materials 78 and 4.

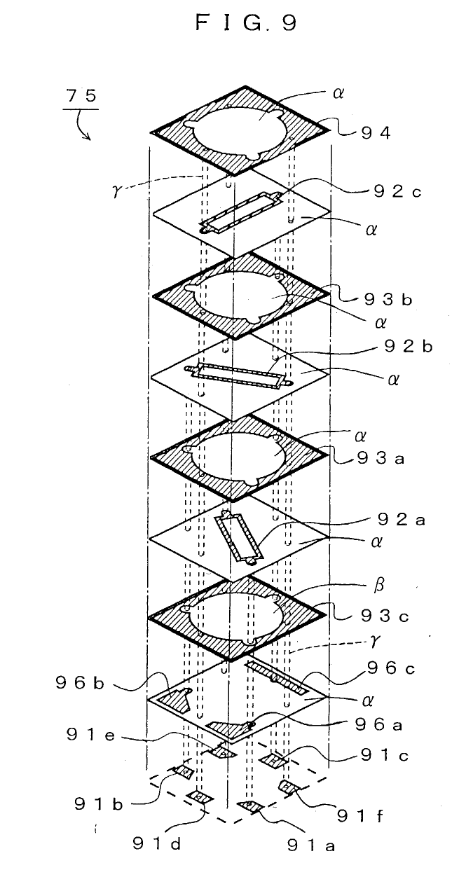

The structure of the multilayer substrate 75 will be described with reference to FIG. 9. The multilayer substrate 75 has the same structure as that of the multilayer substrate 30, according to the second embodiment, which was described with reference to FIG. 3. Then, in FIG. 9, the parts corresponding to the parts allotted to reference numerals in the 30s in the multilayer substrate 30 are allotted by reference numerals in the 90s and thus, reference numerals in single figure and alphabets allotted at the end of the numerals which are allotted to parts of the multilayer substrate 75 (FIG. 9) are common to those of the multilayer substrate 30 (FIG. 3).

The multilayer substrate 75 is different from the multilayer substrate 30, according to the second embodiment of the present invention, in that an electrode 94 for connecting the yoke material is disposed on the upper surface of the multilayer substrate 75. The electrode 94 is connected to other ends of the center electrodes 92a, 92b and 92c through via hole conductors γ.

The multilayer substrate 75 thus structured is connected to the input-output terminal part 77 as shown in FIG. 7. The input-output terminal part 77 is configured so that input-output terminals 77a, 77b and 77c are housed in a resin structure body. The input-output terminal part 77 has input-output terminals 77a to 77c connected to outer circuits (not shown). The input-output terminals 77a to 77c are housed in the resin structure body by insert molding. The input-output terminal 77c is not shown in FIG. 7 because it is positioned at a hidden part. Input-output electrodes 76a, 76b, 76c, 76d, 76e and 76f are provided on the upper surface of the input-output terminal part 77 in the figure. The input-output electrodes 76a to 76c are extended in the input-output terminal part 77 to be connected to the input-output terminals 77a to 77c, respectively. The input-output electrodes 76d to 76f are extended to the lower surface of the input-output terminal part 77 to be connected to the yoke material 78.

Terminal electrodes 91a to 91f for internal connections disposed on the lower surface of the multilayer substrate 75 in the figure are connected to the input-output electrodes 76a to 76f. The yoke material 78 comprises a body part 78a and bent parts 78b. The body part 78a has a flat-plate structure. The bent parts 78b are bent from both ends of the body part 78a at an almost 90 degrees angle. Projections 78h and 78i are provided at ends of the bent parts 78b. As shown in FIGS. 7 and 8, the projections 78h and 78i are bent on the upper surface of the multilayer substrate 75 after the input-output terminal part 77, the ferrite member 2 and the multilayer substrate 75 were housed in the yoke material 78. The bent projections 78h and 78i are connected to the electrode 94 for connecting the yoke material formed on the multilayer substrate 75.

According to the circulator of this embodiment of the present invention,

the earth electrodes 93a and 93b are disposed between the center electrodes 92a to 92c,

On one end, the center electrodes 92a to 92c are connected to the earth electrodes 93a and 93b, and

The electrode 94 (connected to the earth electrodes 93a to 93c) for connecting the yoke material provided on the surface of the multilayer substrate 75 is directly connected to the yoke material 78.

Thus, a potential equalization property of each of the center electrodes 92a to 92c on the earth side is improved and the insertion loss characteristic is improved. Furthermore, earth impedance in the multilayer substrate 75 is reduced by using low impedance of the yoke materials 4 and 78, so that the insertion loss characteristic can be improved.

Measured results of the insertion loss characteristics of the circulator, according to this embodiment, and the circulator, according to the second embodiment, are shown in a table 3. The measurement was performed under the condition that the center frequency is 1.96 GHz and a device size of the circulator is 3 mm square.

TABLE 3

| | Insertion loss (dB) |
|---|---|
| First structure of | 0.65 |
| second embodiment | |
| Third embodiment | 0.58 |

According to the circulator of this embodiment of the present invention, since the electrode 94 (connected to the earth electrodes 93a to 93c) for connecting the yoke material provided on the surface of the multilayer substrate 75 is directly connected to the yoke material 78, the earth impedance in the multilayer substrate 75 is further reduced as compared to the case, according to the second embodiment, so that the insertion loss characteristic is further improved.

In addition, the connection structure between the yoke materials 4 and 78, and the earth electrodes of the multilayer substrate 75 is not limited to that in this embodiment and the same effect can be provided so long as the earth electrodes 93a to 93c of the multilayer substrate 75 are directly connected to either upper or lower yoke material 4 or 78.

The aforementioned embodiments 1 to 3 are further preferably configured as follows. According to the embodiments 1 to 3, there are the following via hole conductors γ.

via hole conductor γ connected to an earth electrode connection end (one end) of the center electrode (hereinafter, it is referred to as a first via hole conductor γ)

via hole conductor γ connected to another electrode pattern in the multilayer substrate other than the earth electrode connection end (one end) of the center electrode (hereinafter, it is referred to as a second via hole conductor γ)

via hole conductor connected to a capacitor connection end (one end) of the center electrode other than the earth electrode connection end (the other end) of the center electrode (hereinafter, it is referred to as a third via hole conductor γ)

According to the above via hole conductors γ, the electric resistance of the first via hole conductor γ is preferably made lower than that of the second and third via hole conductors γ. For example, the electric resistance of the first via hole conductor γ can be lowered by increasing the total sectional area of that via hole conductor γ. In addition, the electric resistance can be lowered by adjusting conductor material of the first via hole conductor γ. Thus, the earth impedance in the multilayer substrate can be reduced.

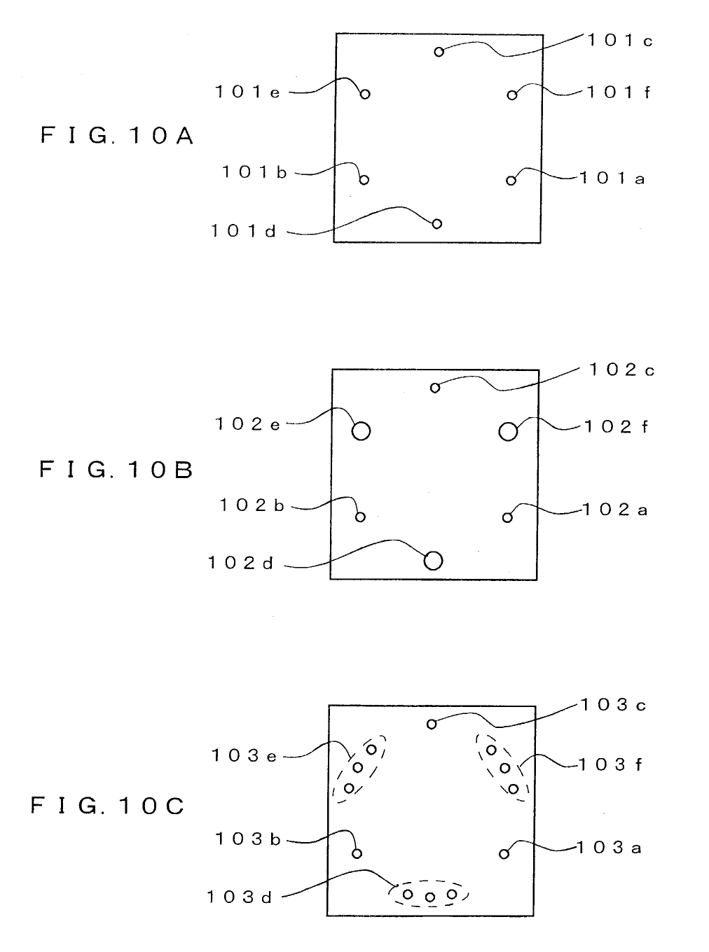

FIG. 10A illustrates structures and positions of the via hole conductors γ, according to the first to third embodiments of the present invention. FIG. 10B illustrates structures and positions of the via hole conductors γ, according to the first improved example. FIG. 10C illustrates configurations and positions of the via hole conductors γ according to the second improved example. These figures are sectional views taken along the plane direction of the multilayer substrate. All of the electrode patterns shown in FIG. 3 are employed for the electrode patterns in the multilayer substrate connected to the via hole conductors γ. As the structure of the whole circulator, the structure of the circulator shown in FIG. 31 which was described in the prior art is employed. Referring to FIGS. 10A to 10C, reference numerals (101a, 101b and 101c), (102a, 102b and 102c) and (103a, 103b and 103c) designate the second and third via hole conductors γ which are connected to the terminal electrodes 31a, 31b and 31c for internal connections in FIG. 3, but not connected to the earth electrodes. Reference numerals (101d, 101e and 101f) , (102d, 102e and 101f) and (103d, 103e and 103f) designate the first via hole conductors γ which are connected to the earth electrodes.

According to FIG. 10A, all of the via hole conductors γ 101a to 101f have the same diameter and individually are formed.

According to the first improved example shown in FIG. 10B,

the second and third via hole conductors 102a to 102c have the same diameter as that of the second and third via hole conductors 101a to 101c shown in FIG. 10A.

the first via hole conductors 102d to 102f have a diameter larger (twice the size in this example) than that of the first via hole conductors 101d to 101f shown in FIG. 10A and are individually formed.

According to the second improved example shown in FIG. 10C,

all of the via hole conductors 103a to 103f have the same diameter,

the second and third via hole conductors 103a to 103c are individually formed, and

first via hole conductors 103d to 103f are each composed of three via hole conductors.

In addition, the electrode patterns shown in FIG. 3 correspond to configurations and positions of the via hole conductors 101a to 101f shown in FIG. 10A. In the structure shown in FIG. 3, if the structure of the via hole conductors in the first and second improved examples shown in FIGS. 10B and 10C is employed, it is necessary to change the configurations of the electrode patterns of the multilayer substrate connected to the via hole conductors according to the change of the configurations of the via hole conductors.

According to the circulator using the first and second improved example of the via hole conductors, the total sectional area of the via hole conductors connected to the earth electrodes and its electric resistance are low, earth impedance in the multilayer substrate is reduced and the insertion loss characteristic is improved as compared to the circulator which does not employ these improved examples.

Measured results of the insertion loss characteristics of the circulator in which the first and second improved examples of the via hole conductors are employed in the first structure of the second embodiment are shown in table 4. The measurement was performed under the condition that the center frequency is 1.96 GHz and a device size of the circulator is 3 mm square.

TABLE 4

| | Insertion loss (dB) |
|---|---|
| First structure of | 0.65 |
| second embodiment | |
| First improved example | 0.54 |
| of first to third | |
| embodiments | |
| Second improved example | 0.57 |
| of first to third | |
| embodiments | |

According to the circulator which employed the first and second improved examples of the via hole conductors, earth impedance in the multilayer substrate is reduced and its insertion loss characteristic is improved as compared to the circulator which did not employ these improved examples.

In addition, according to the structure in the first improved example, although it is thought that the same improved characteristic effect can be obtained even when the diameters of all of the via hole conductors 101a to 101f are increased under a condition that the diameters are the same, the following inconvenience will arise.

The total sectional area of via hole conductors y occupying the element sectional area is increased and a crack is likely to be generated in the substrate as a matter of processing concerned.

The total sectional area of via hole conductors y on the side connected to the input-output terminals is increased and unnecessary capacity is likely to superimpose on a transmission line as a matter of circuit concerned.

In view of the above problems, it is preferable to employ the first improved example (the total sectional area of the via hole conductors γ on the side where the earth electrodes are connected is increased).

Furthermore, the first and second improved examples of the via hole conductors γ are implemented not only in the circulators described in the above first to third embodiments of the present invention, but also in the conventional structure in which there is no earth electrode between layers of the center electrodes, and the same effect can be provided.

The structures, according to the above first and second improved examples, are not limited to the above and the same effect can be obtained so long as it is within the scope of the present invention. In addition, the first via hole conductor γ may be formed of a conductor material having electric conductivity higher than that of the conductor material of the second and third via hole conductors γ under the condition that the total sectional area of via hole conductors γ is the same.

(Fourth Embodiment)

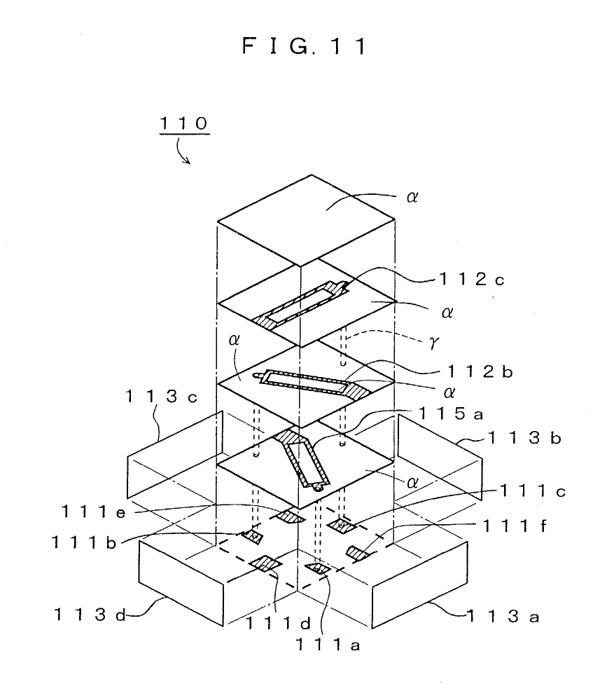

A fourth embodiment of the present invention refers to a non-reciprocal circuit element in which the ends on the earth side (the other ends) of the center electrode are extended to the end surface of the multilayer substrate and connected to earth electrodes formed on the end surface of the multilayer substrate. FIG. 11 illustrates the structure of a multilayer substrate 110 of a circulator according to the fourth embodiment of the present invention.

Since the whole structure of the circulator is the same as that of the circulator shown in FIG. 29, its detailed description will be omitted.

The multilayer substrate 110 comprises center electrodes 112a, 112b and 112c each having elongated rectangular frame shape in plan view. The center electrodes 112a to 112c are arranged and layered so that longitudinal parts intersect with each other at an angle of 120 degrees in plan view. The center electrodes 112a to 112c are layered through insulating layers α, respectively.

Terminal electrodes 111a, 111b, 111c, 111d, 111e and 111f for internal connections are disposed on a lower surface of the multilayer substrate 110. Among the above electrodes, one end of the electrodes 111d to 111f is extended to the end surface of the multilayer substrate 110.

One end of the center electrodes 112a to 112c is connected to the terminal electrodes 111a to 111c through via hole conductors γ. The other ends of the center electrodes 112a to 112c are extended to the end surface of the multilayer substrate 110. Earth electrodes 113a, 113b, 113c and 113d are formed on the whole of the four end surfaces except for the upper and lower surfaces of the multilayer substrate 110. The other ends of the center electrodes 112a to 112c are connected to the earth electrodes 113a to 113d. The center electrodes 112a to 112c are connected to the terminal electrodes 111d to 111f for internal connections through the earth electrodes 113a to 113d. In the figure, the connections through the via hole conductors γ are conceptually shown by thin broken lines.

According to the circulator of this embodiment of the present invention,

the other ends of the three center electrodes 112a to 112c formed on separate layers are connected to the earth electrodes 113a to 113d formed on the end surfaces of the multilayer substrate 110.

Thus, potential equalization property of the center electrodes 112a to 112c on the earth side is improved and its insertion loss characteristic can be improved.

Measured results of the insertion loss characteristics in the circulator, according to this embodiment and the conventional circulator shown in FIG. 29, are shown in a table 5. The measurement was performed under the condition that the center frequency is 1.96 GHz and a device size of the circulator is 3 mm square.

TABLE 5

| | Insertion loss (dB) |
|---|---|
| Conventional example | 0.82 |
| Fourth embodiment | 0.70 |

According to the circulator of this embodiment of the present invention, the potential equalization property of each of the center electrodes on the earth side and the insertion loss characteristic are improved.

In addition, the electrode pattern and position of each electrode shown in the above embodiments are not limited to the above, and it is changeable so long as it is within the scope of the present invention, so that the same effect can be obtained. For example, these embodiments can be applied to a structure in which the capacitor described with reference to FIG. 31 in the prior art is integrated in the multilayer substrate.

(Fifth Embodiment)

A fifth embodiment of the present invention refers to a non-reciprocal circuit element in which

center electrodes and a capacitor part are composed of a multilayer substrate,

a capacitor is composed of a pair of counter electrodes opposed to each other across the dielectric layer β, and

the counter electrode on the earth side of the counter electrodes is exposed on the surface of the multilayer substrate.

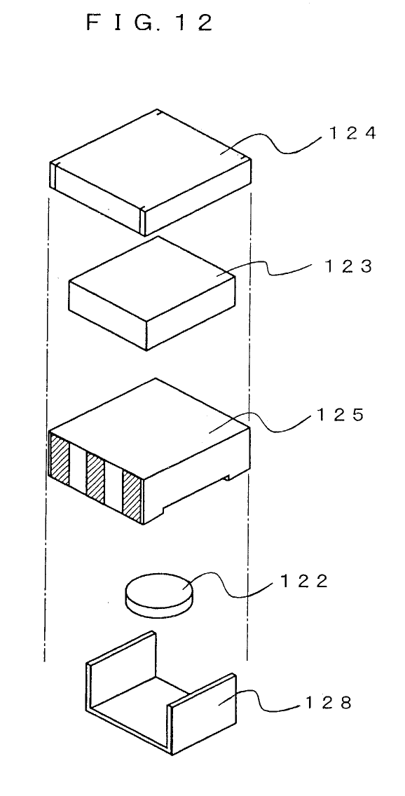

Structure of a circulator will be described with reference to FIGS. 12 to 14.

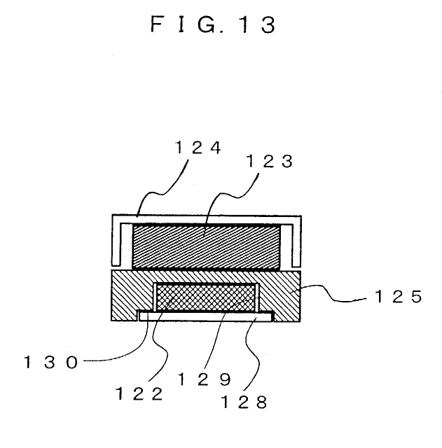

In a multilayer substrate 125, the center electrodes and the capacitor part are formed. The multilayer substrate 125 comprises a terminal part for outer connections and an input-output terminal part. As shown by a sectional view in FIG. 13, cavities 129 and 130 are formed on the lower surface of the multilayer substrate 125 in the figure. The cavity 129 houses a ferrite member 122. The cavity 130 houses a yoke material 128. Since the ferrite member 122 and the yoke material 128 are housed in the cavities 129 and 130, respectively, the outer connection terminals provided on the lower surface of the multilayer substrate 125 in the figure abut on a mounted surface of the element.

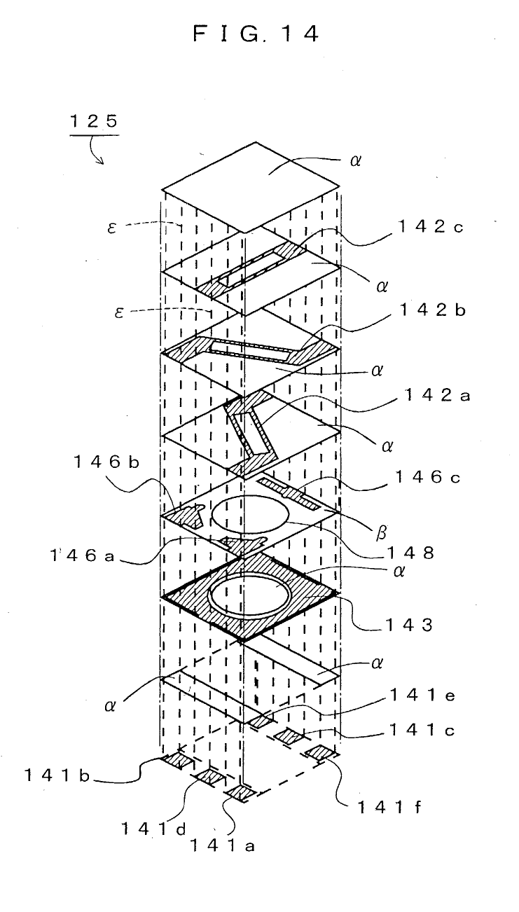

The structure of the multilayer substrate 125 is shown in FIG. 14. The multilayer substrate 125 comprises center electrodes 142a, 142b and 142c. The center electrodes 142a to 142c are layered so that their longitudinal parts intersect with each other at an angle of 120 degrees with an insulating layer α disposed therebetween. Electrodes 146a, 146b and 146c for forming a capacitor are disposed so as to be opposite the center electrode 142a across the insulating layer α in between. The earth electrode 143 is disposed so as to be opposed to counter electrodes 146a to 146c with a dielectric layer β disposed therebetween. Terminal electrodes 141a, 141b, 141c, 141d, 141e and 141f for outer connections are disposed so as to be opposite both ends of the earth electrode 143 in the plane direction with the insulating layer α disposed therebetween. The center of the earth electrode 143 in the plane direction is exposed on the lower surface of the multilayer substrate 125 in the figure. Since the insulating layer α and the electrodes 141a to 141f are provided only both ends of the earth electrode 143, a cavity 130 is formed at the center (the exposed part of the earth electrode 143) of the lower surface of the multilayer substrate 125 in the figure. A yoke material 128 is housed in the cavity 130. The housed yoke material 128 abuts on the earth electrode 143 so as to be connected.

One end of the center electrodes 142a to 142c is connected to counter electrodes 146a, 146b and 146c for forming the capacitor, and the terminal electrodes 141a, 141b and 141c through electrode patterns ε formed on the side surface of the multilayer substrate 125. The electrodes 146a to 146c and the electrodes 141a to 141c are connected in such a manner that ones on the same position in the lateral direction are connected to each other through the electrode patterns ε on the side surface of the multilayer substrate 125. Referring to FIG. 14, the same alphabets are allotted to the end of the reference numerals for the electrodes 146a to 146c and the electrodes 141a to 141c to be connected to each other.

The other ends of the center electrodes 142a to 142c are connected to the earth electrode 143 through the electrode patterns ε formed on the side surface of the multilayer substrate 125. At the same time, the other ends of the center electrodes 142a to 142c are connected to the terminal electrodes 141d to 141f for outer connections through the electrode patterns ε.

An opening 148 for forming a cavity 129 is provided in each layer under the center electrode 142a. In FIG. 14, the electrode patterns ε for connections are conceptually shown by broken lines.

According to the circulator of this embodiment of the present invention,

electrodes of the capacitor on the earth side, which are exposed on the multilayer substrate surface are grounded by using low impedance of the yoke material.

Thus, earth impedance in the multilayer substrate 125 is reduced and its insertion loss characteristic can be improved.

Measured results of insertion loss characteristics in the circulator according to this embodiment and the conventional circulator shown in FIG. 31 are shown in table 6. The measurement was performed under the condition that the center frequency is 1.96 GHz and a device size of the circulator is 3 mm square.

TABLE 6

| | Insertion loss (dB) |
|---|---|
| Conventional example | 0.91 |
| Fifth embodiment | 0.73 |

According to the circulator of this embodiment of the present invention, the earth impedance in the multilayer substrate is reduced and its insertion loss characteristic is improved.

In addition, the electrode pattern and position of each electrode shown in the above embodiments is not limited to the above, and it is changeable so long as it is within the scope of the present invention, so that the same effect can be obtained.

In the above first to fifth embodiments of the present invention, the present invention was described using the circulator in which a center frequency is 1.96 GHz and a device size is 3 mm square as a typical non-reciprocal circuit element. However, the present invention can be effective to another circulator having a different center frequency and device size. In addition, the present invention has the same effect in an isolator in which one of input-output terminals is ended by a resistor. Furthermore, the present invention can be implemented for components of the non-reciprocal circuit element other than the multilayer substrate without any particular limitation.

(Sixth Embodiment)

A sixth embodiment of the present invention refers to a communication circuit module provided with a non-reciprocal circuit element. In general, the communication circuit module is composed by integrating at least two or more devices and a circuit element in a multilayer substrate, which constitutes a wireless part of a mobile communication device.

As examples of such a device, there are a duplexer, an LPF (Low Pass Filter), a BPF (Band Pass Filter), a switch, a PA (Power Amplifier) and the like. As a circuit element, there are a capacitor, an inductor, a resistor and the like.

In recent years, since circuit parts have been increasingly made IC-compatible, some communication circuit modules have the following structures. According to this kind of communication circuit module, land pattern for mounting IC or the like is provided on a mounting substrate surface. The IC is mounted on the land pattern and an IC mounted surface is resin-molded and packaged.

In the following description, a structure of the communication circuit module other than a part comprising a non-reciprocal circuit element is not referred to because it does not have an effect on the present invention.

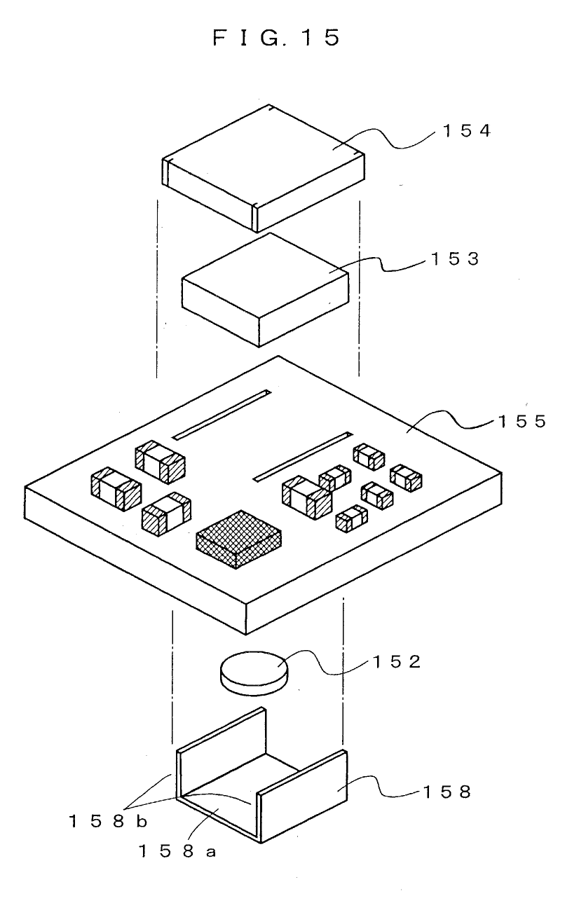

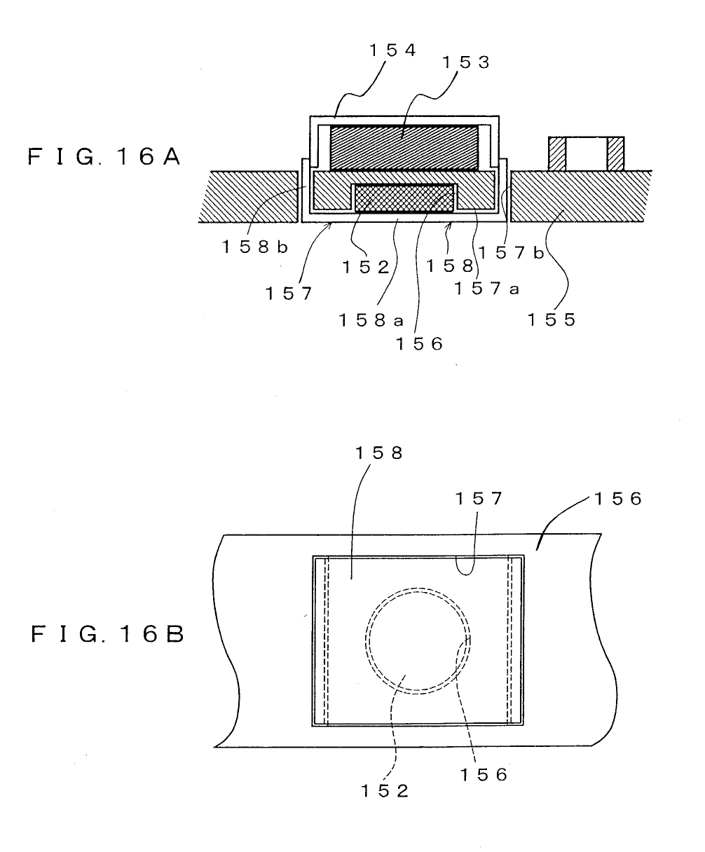

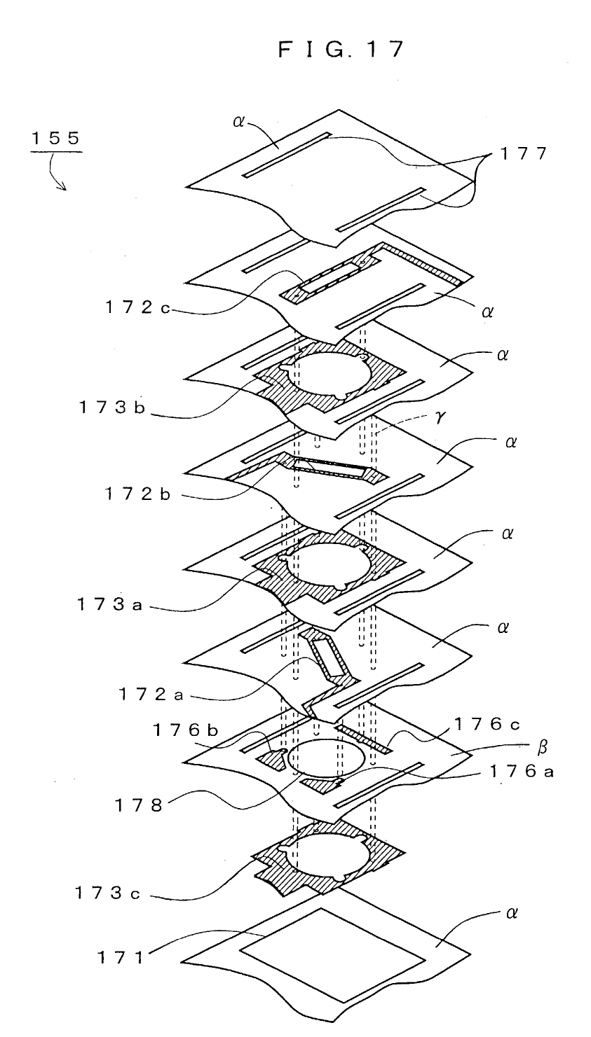

A first structure of this embodiment will be described with reference to FIGS. 15 to 17. Referring to FIG. 15, center electrodes and a capacitor part of a circulator are formed in a multilayer substrate 155. The multilayer substrate 155 also functions as the main component of the whole communication circuit module. Parts such as various kinds of chips are mounted on the surface of the multilayer substrate 155 and circuit elements are built in it. A sectional view of an essential part of the communication circuit module in which the circulator is composed is shown in FIG. 16A and its back side view is shown in FIG. 16B.

A cavity 156 for housing a discoid ferrite member 152, and a cavity 157 for receiving a yoke material 158 are provided in the multilayer substrate 155. The cavity 156 has a size for housing the ferrite member 152 and it is formed on one side of the multilayer substrate 155.

The yoke material 158 comprises a flat-plate body part 158a and bent parts 158b. The bent parts 158b are bent from both ends of the body part 158a at an almost 90 degrees angle and have a length dimension such that the multilayer substrate 155 can be fit in the thickness direction.

The cavity 157 is provided on one side of the multilayer substrate 155 and comprises a groove part 157a cutting across the cavity 156 and through holes 157b are provided on both ends of the groove part 157a and piercing the multilayer substrate 155. The groove part 157a has the same depth as the thickness of the yoke material 158 and horizontal and vertical dimensions such that the body 158a of the yoke material 158 can be housed.

The through hole 157b has a size such that the bent part 158b of the yoke member 158 can pass through it. The distance between the both through holes 157b and 157b is set so as to be the same as the distance between the bent parts 158b.

In a state in which the ferrite member 152 is housed in the cavity 156, the yoke material 158 is housed in the cavity 157. In this state, the yoke material 158 is mounted in the cavity 157. More specifically, the bent parts 158b are inserted into the through holes 157b and the body 158a is housed in the groove part 157a. A depth dimension provided by adding up the depth dimension of the cavity 156 and the depth dimension of the groove part 157a are set so as to be the same as or a little bigger than a thickness dimension provided by adding up the thickness dimension of the ferrite member 152 and the thickness dimension of the yoke material 158. As a result, in a state where the ferrite member 152 and the yoke material 158 are housed in the multilayer substrate 155, the yoke material 158 will not protrude from the surface of the multilayer substrate 155.

Meanwhile, a magnet 153 is disposed on a surface of the multilayer substrate 155 opposite to the surface in which cavities are formed. The magnet 153 is disposed so as to be opposite to the ferrite member 152 across the multilayer substrate 155. A yoke material 154 is disposed so as to cover the magnet 153 on the multilayer substrate 155. The edge of the bent part 158b of the yoke material 158 which passed through the through hole 157b is engaged with the yoke material 154.

According to the thus-formed communication circuit module, the surface (corresponding to the surface in which cavities are formed) on which the module is mounted on another member becomes the same surface. This is because the ferrite member 152 and the yoke material 158 are housed in the cavity 156 and the cavity 157 so that the yoke material 158 does not protrude from the module mounting surface.

A structure of the multilayer substrate 155 is shown in FIG. 17. Center electrodes 172a, 172b and 172c are layered and disposed so that their longitudinal parts intersect with each other at an angle of 120 degrees in a plan view. Earth electrodes 173a and 173b are disposed between the center electrodes 172a to 172c, one by one. The insulating layers α serving as an electrical isolation layer are disposed between the center electrodes 172a to 172c and the earth electrodes 173a and 173b.

Counter electrodes 176a, 176b and 176c for forming a capacitor, which are disposed outside of the center electrode 172a, are disposed at the end. The electrodes 176a to 176c are arranged on the same plane. The counter electrodes 176a to 176c located opposite the center electrode 172a through the insulating layer α. An earth electrode 173c is disposed more outside of the counter electrodes 176a to 176c. The earth electrode 173c is disposed so as to be opposite the counter electrodes 176a to 176c through a dielectric layer β.

An opening 178 for forming the cavity 156 is provided in the dielectric layer β disposed between the counter electrodes 176a to 176c and the earth electrode 173c. The insulating layer α is provided outside the multilayer substrate of the earth electrode 173c. An opening 171 for forming the groove part 157a of the cavity 157 is provided in this insulating layer α. The earth electrode 173c is exposed on the surface of the multilayer substrate 155 because of the groove part 157a formed by the opening 171. Openings 177 for forming the through holes 157b of the cavity 157 is provided in each insulating layer α constituting the multilayer substrate 155.

One end of the center electrodes 172a to 172c are connected to the earth electrodes 173a to 173c through via hole conductors γ. The other ends of the center electrodes 172a, 172b and 172c are connected to the counter electrodes 176a to 176c, respectively through via hole conductors γ. The same alphabets are allotted to the ends of the reference numerals for the center electrodes 172a to 172c and the counter electrode 176a to 176c to be connected to each other. In addition, leader lines are connected to the other ends of the center electrodes 172a to 172c to be connected to predetermined circuits in the communication circuit module.

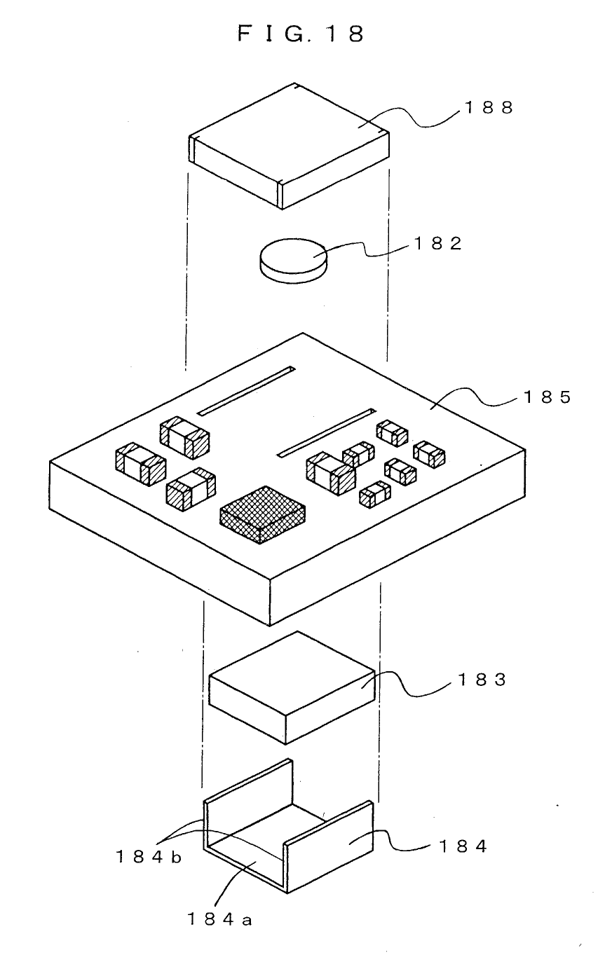

A second structure according to this embodiment of the present invention is described with reference to FIGS. 18 to 20. The second structure is basically the same as the aforementioned first structure. In FIGS. 18 to 20 showing the second structure, reference numerals in the 180s and 200s are allotted. Parts to which reference numerals in the 180s are allotted correspond to the parts to which reference numerals in the 150s are allotted in the first structure and parts to which reference numerals in the 200s are allotted correspond to the parts to which reference numerals in the 170s are allotted in the first structure. Here, among corresponding reference numerals, the reference numerals allotted to a single figure and alphabets allotted to the end of the reference numerals are common between the first and second structures.

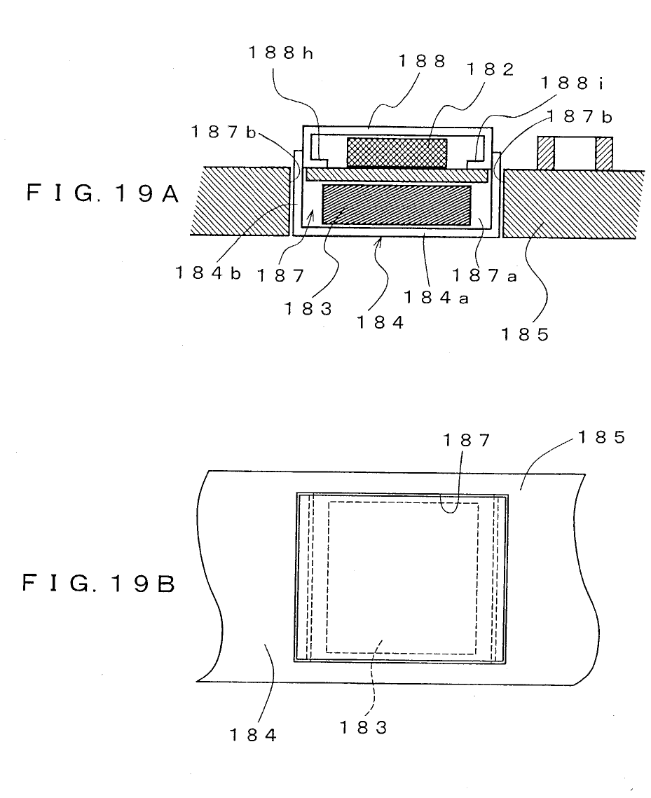

Referring to FIG. 18, center electrodes of a circulator are formed in a multilayer substrate 185. The multilayer substrate 185 also functions as the main component of the whole communication circuit module. Parts such as various kinds of chips are mounted on the surface of the multilayer substrate 185 and circuit elements are built in it. A sectional view of an essential part of the communication circuit module in which the circulator is composed is shown in FIG. 19A and its back side view is shown in FIG. 19B.

A cavity 187 for hosing a magnet 183 and a yoke material 184 is provided on one side of the multilayer substrate 185. The cavity 187 has a size for housing the magnet 183 and the yoke material 184. The depth dimension of the cavity 187 is the same as or a little bigger than a dimension provided by adding up the thickness dimension of the magnet 183 and the thickness dimension of the yoke material 184.

The yoke material 184 comprises a flat-plate body part 184a and bent parts 184b. The bent parts 184b are bent from both ends of the body part 184a at an almost 90 degrees angle and have a length dimension in the thickness direction such that the multilayer substrate 185 can fit in.

The cavity 187 has a body 187a and through holes 187b provided on both ends of the body 187a and piercing the multilayer substrate 185.

The through hole 187b has a size such that the bent part 184b of the yoke material 184 can pass through. The distance between the both through holes 187b and 187b is set so as to be the same as the distance between the bent parts 184b and 184b.

The yoke material 184 is housed in the cavity 187 in a state where the magnet 183 is housed in the body 187a of the cavity 187. More specifically, the bent parts 184b are inserted into the through holes 187b and the body 184a is housed in the body 187a. The depth dimension of the cavity 187 is set so as to be the same as or a little bigger than a thickness dimension provided by adding up the thickness dimension of the magnet 183 and the thickness dimension of the yoke material 184. Therefore, in the state where the magnet 183 and the yoke material 184 are housed in the multilayer substrate 185, the yoke material 184 will not protrude from the surface of the multilayer substrate 185.

Meanwhile, a ferrite member 182 is disposed on a side surface of the multilayer substrate 185 opposite to the surface in which the cavities are formed. The ferrite member 182 located opposite the magnet 183 across the multilayer substrate 185. A yoke material 188 is provided so as to cover the ferrite member 182 on the multilayer substrate 185. The edges of the bent parts 184b of the yoke material 184 which pierced the through holes 187b are engaged with the yoke material 188.

According to the thus-formed communication circuit module, the surface (corresponding to the surface in which cavities are formed) on which the module is to be mounted on another member becomes the same surface. This is because the magnet 183 and the yoke material 184 are housed in the cavity 187 and the yoke material 184 does not protrude from the module mounting surface.

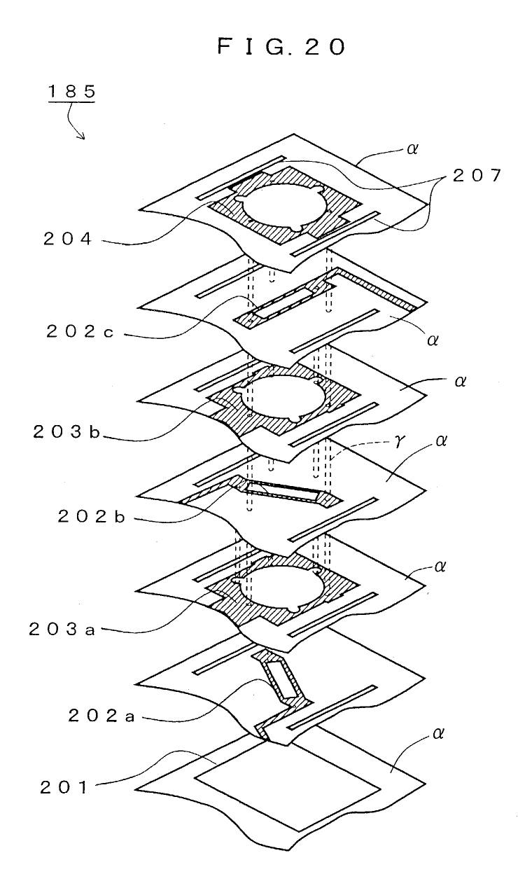

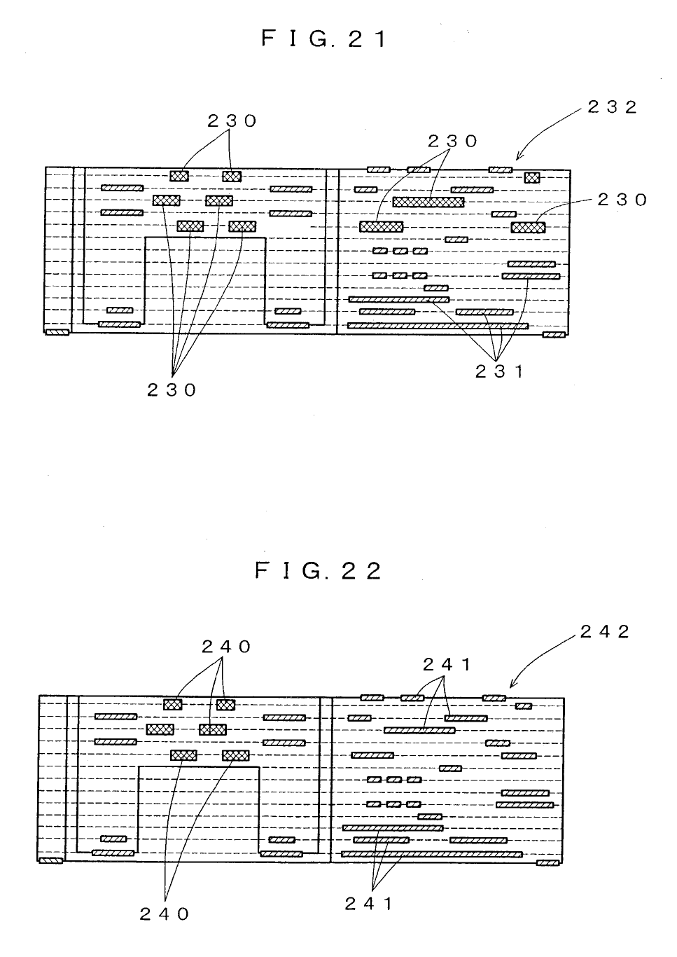

A structure of the multilayer substrate 185 is shown in FIG. 20. Center electrodes 202a, 202b and 202c are layered and disposed so that their longitudinal parts intersect with each other at an angle of 120 degrees in a plan view. Electrodes 203a and 203b are disposed between the center electrodes 202a to 202c, one by one. The insulating layers are disposed between the center electrodes 202a to 202c and the earth electrodes 203a and 203b, respectively.

An electrode 204 for connecting the yoke material that is disposed outside of the center electrode 202c is disposed at the end. The electrode 204 is disposed so as to be opposite the center electrode 202c through the insulating layer a.

The insulating layer α is also provided outside the center electrode 202a in the thickness direction of the multilayer substrate. An opening 201 for forming the body 187a of the cavity 187 is provided in this insulating layer α. The center electrode 202a is exposed on the surface of the multilayer substrate 185 because of the body 187a of the cavity 187 formed by the opening 201. In addition, the insulating layer α may be further provided between the body 187a of the cavity 187 and the center electrode 202a. Openings 207 for forming the through holes 187b of the cavity 187 are provided in each insulating layer a constituting the multilayer substrate 185.

The center electrodes 202a to 202c are, on one end, connected to the earth electrodes 203a and 203b and the electrode 204 for connecting the yoke material through via hole conductors γ. The center electrodes 202a and 202b are, on one end, connected by leader lines in parallel to a capacitor (not shown) which is formed in the multilayer substrate 185. On the other end, the center electrodes 202a and 202b are connected to leader lines to connect predetermined circuits in the communication circuit module.

The electrode 204 for connecting the yoke material, which is exposed on the surface of the multilayer substrate 185, is connected to projections 188h and 188i provided in the yoke material 188.

According to the first and second structures of this embodiment of the present invention, positions of the ferrite member and the magnet are reversed. Accordingly, the structure of the multilayer substrate and the structures of the cavities provided in the multilayer substrate are a little different.

According to the communication circuit module of this embodiment of the present invention, there is no projection which becomes a problem in view of mounting on a surface of the communication circuit module. More specifically, the yoke material housed in the multilayer substrate and the multilayer substrate are on the same surface. This kind of communication circuit module can be easily mounted onto a circuit substrate such as a mobile phone or the like.

According to the communication circuit module of this embodiment of the present invention, as compared with a case where a circulator is mounted on a substrate as a single part as in the prior art, it is less necessary to consider a positional relation with parts arranged around it. Therefore, the circulator can be taken in the communication circuit module while an effective occupied space is reduced.

According to the communication circuit module of this embodiment of the present invention, since the earth electrode connected to one end of the center electrodes is provided between layers in which the center electrodes of the circulator are formed in the multilayer substrate, non-reciprocal circuit element provided with excellent electric properties can be built in.

(Seventh Embodiment)

A seventh embodiment of the present invention has a feature in a structure of a multilayer substrate. FIG. 21 illustrates a first structure and FIG. 22 illustrates a second structure of this embodiment.

As shown in FIG. 21, according to the first structure of this embodiment of the present invention, the electrode thickness of each electrode pattern 230 on a layer on which the center electrode is formed in a multilayer substrate 232 is set so as to be larger than the electrode thickness of each electrode pattern 231 of another layer. As a result, conductor loss at the center electrode part is reduced and loss at the circulator part can be reduced.

As a method of implementing the above structure,

the electrode patterns 230 on the same plane including the center electrodes are selectively formed by printing several times, or

when the electrode patterns 230 on the same plane including the center electrodes are formed, a mesh of a printing screen or printing conditions are adjusted so that the electrode patterns 230 may be formed thick.

The effect provided by employing the structure in FIG. 21 is favorable regardless of its forming method. According to the second structure of this embodiment, as shown in FIG. 22, only the electrode thickness of the electrode pattern 240 which is the center electrode in the multilayer substrate 242 is set so as to be larger than the electrode thickness of another electrode pattern 241. In this case, another electrode pattern 241 comprises an electrode pattern formed on the same layer (the same plane position) as the electrode pattern 240.

As a result, conductor loss at the center electrode part is reduced and loss at the circulator part can be reduced.

As a concrete method of implementing the above structure, there is a method in which only the center electrode part is formed by printing several times. The effect provided by employing the structure in FIG. 22 is good regardless of its forming method.

(Eighth Embodiment)

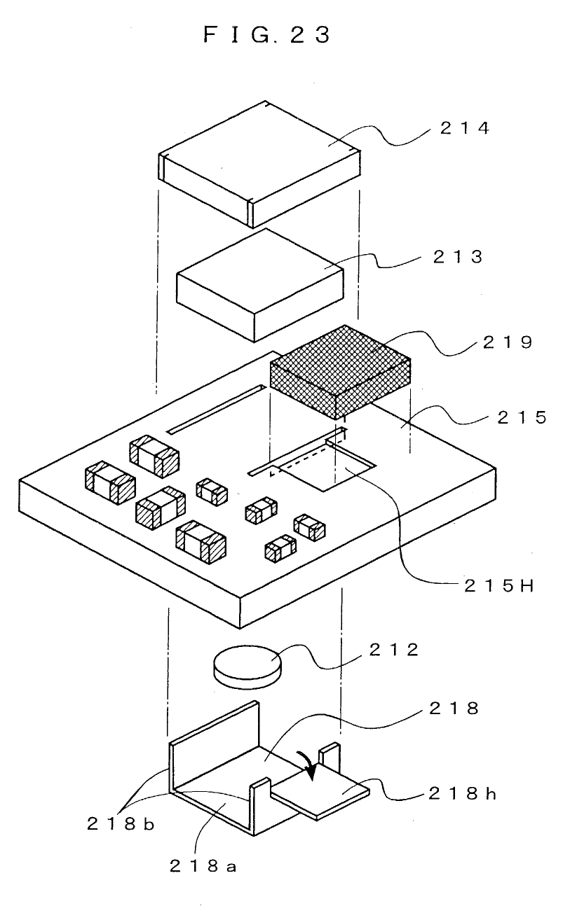

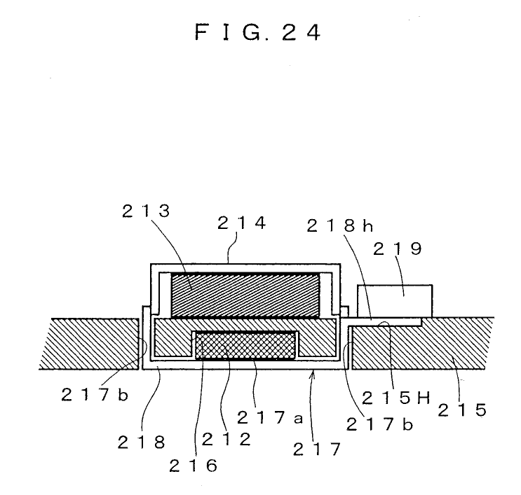

An eighth embodiment of the present invention refers to a communication circuit module provided with a non-reciprocal circuit element. The communication circuit module of this embodiment will be described with reference to FIGS. 23 and 24.

According to a multilayer substrate 215, center electrodes and a capacitor part are formed inside it. The multilayer substrate 215 constitutes the main component of the whole communication circuit module. A power amplifier 219 is mounted on the surface of the multilayer substrate 215 in addition to parts such as various chips. Since electrode structures and sectional configuration of the circulator are the same as those in other embodiments, their description will be omitted.

A cavity 216 for housing a discoid ferrite member 212, and a cavity 217 for receiving a yoke material 218 are provided in the multilayer substrate 215. The cavity. 216 has a size for housing the ferrite member 212 and it is formed on one side of the multilayer substrate 215.

The yoke material 218 comprises a flat-plate body part 218a and bent parts 218b. The bent parts 218b are bent from both ends of the body part 218a at an almost 90 degrees angle and have a length dimension such that the multilayer substrate 215 can be fit in the thickness direction.

The cavity 217 is provided on one side of the multilayer substrate 215 and comprises a groove part 217a cutting across the cavity 216 and through holes 217b provided on both ends of the groove part 217a and piercing the multilayer substrate 215. The groove part 217a has the same depth dimension as the thickness of the yoke material 218 and horizontal and vertical dimensions such that the body 218a of the yoke material 218 can be housed.

The through hole 217b has a size such that the bent part 218b of the yoke member 218 can pass through. The distance between the through holes 217b and 217b is set so as to be the same as the distance between the bent parts 218b.

In a state in which the ferrite member 212 is housed in the cavity 216, the yoke material 218 is housed in the cavity 217. In this state, the yoke material 218 is mounted in the cavity 217. More specifically, the bent parts 218b are inserted into the through holes 217b and the body 218a is housed in the groove part 217a. A depth dimension provided by adding up the depth dimension of the cavity 216 and the depth dimension of the groove part 217a is set so as to be the same as or a little bigger than a thickness dimension provided by adding up the thickness dimension of the ferrite member 212 and the thickness dimension of the yoke material 218. As a result, in a state where the ferrite member 212 and the yoke material 218 are housed in the multilayer substrate 215, the yoke material 218 will not protrude from the surface of the multilayer substrate 215.

Meanwhile, a magnet 213 is disposed on a surface of the multilayer substrate 215 opposite to the surface in which cavities are formed. The magnet 213 is disposed so as to be opposite the ferrite member 212 across the multilayer substrate 215. A yoke material 214 is disposed so as to cover the magnet 213 on the multilayer substrate 215. The edge of the bent part 218b of the yoke material 218 which passed through the through hole 217b is engaged with the yoke material 214.

In the communication circuit module provided with the above basic structure, according to this embodiment of the present invention, a cavity 215H is provided in the surface of the multilayer substrate 215 on an opposite side of the surface in which the cavities are formed. The cavity 215H is formed so as to be connected to an open end of one through hole 217b. The cavity 215H is disposed on the side opposite to the other through hole 217b. The cavity 215H has a size such that an end portion 218h of the bent part 218b protruding from the one through hole 217b can be housed. The depth dimension of the cavity 215H is set so as to be the same as the thickness dimension of the bent part 218b.

After the bent part 218b was inserted into the through hole 217b, the yoke material 218 is mounted on the multilayer substrate 215. In this state, the end portion 218h of the one bent part 218b is bent toward the side of the cavity 215H and housed in the cavity 215H. At this time, the end portion 218h and the multilayer substrate 215 are on the same surface. In this state, the power amplifier 219 is mounted on the cavity 215H. The mounted power amplifier 219 abuts on the end portion 218h of the yoke material 218.

According to the communication circuit module of this embodiment of the present invention, even when there is a part which generates heat such as a power amplifier 219, the heat of the power amplifier 219 can be effectively released toward the mounted substrate side through the end portion 218h of the yoke material 218. Therefore, favorable heat releasing structure can be implemented without employing a multilayer substrate material having high heat conductivity or using a thermal via. As a result, the degree of freedom of the circuit structure is increased, so that highly integrated communication circuit module can be implemented.

In addition, the contact structure between the yoke material 218 and the mounted heat generating part (power amplifier 219) is not limited to the above structure and it can be changed so long as it is within the scope of the present invention and the same effect can be obtained.

(Ninth Embodiment)

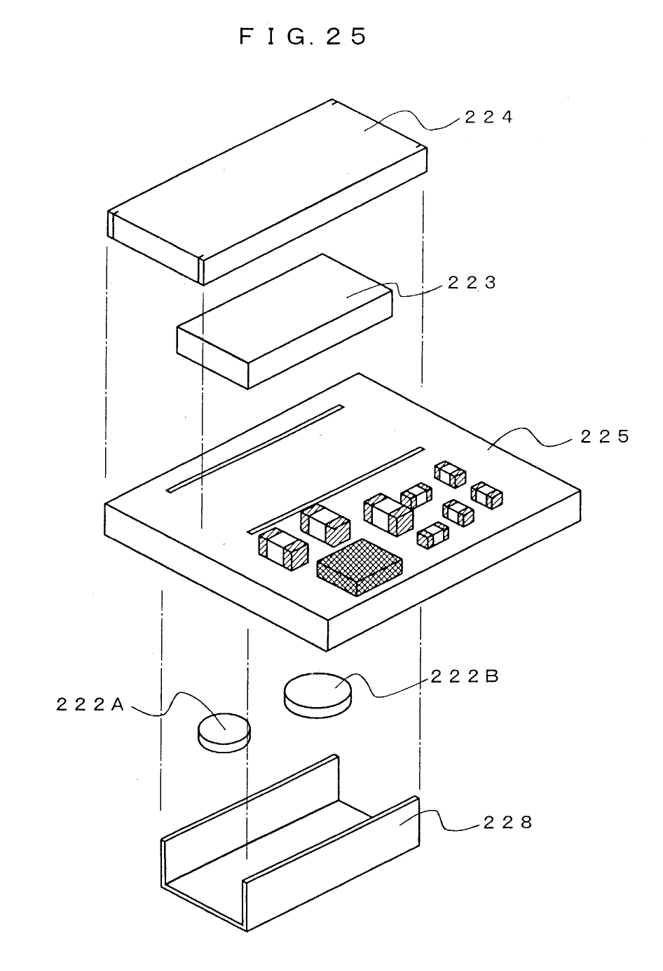

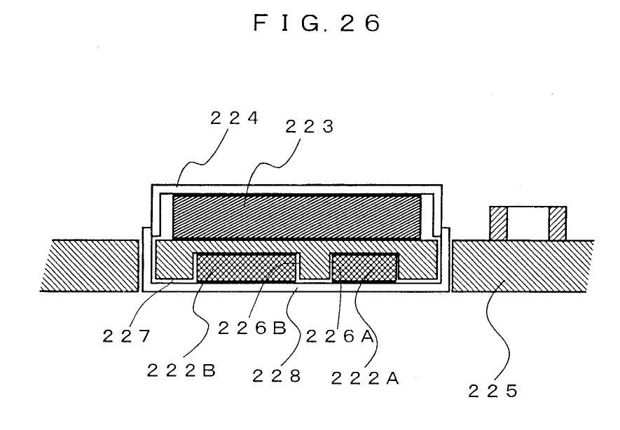

A ninth embodiment of the present invention refers to a communication circuit module provided with a non-reciprocal circuit element. This embodiment is described with reference to FIGS. 25 and 26.

The structure of this embodiment is basically the same as that of the sixth and eighth embodiments in the present invention. In FIGS. 25 and 26 showing this embodiment, reference numerals in the 220s are allotted. Parts to which reference numerals in the 220s are allotted correspond to the parts to which reference numerals in the 150s and 180s are allotted in the sixth embodiment and parts to which reference numerals in the 210s are allotted in the eighth embodiment. Here, among corresponding reference numerals, the reference numerals allotted to a single figure and alphabets allotted to the end of the reference numerals are common between the sixth, eighth and ninth embodiments of the present invention.

The sixth and eighth embodiments refer to a communication circuit module in which a single circulator is built in the multilayer substrates. In this embodiment, however, a plurality of circulators are provided in a multilayer substrate 225. More specifically, center electrodes and a capacitor part of two circulators having different frequency bands to be used are provided in the multilayer substrate 225. A pair of cavities 226A and 226B for housing the ferrite member 222A and 222B, respectively and a cavity 227 for receiving the yoke material 228 are provided in the multilayer substrate 225. The yoke materials 224 and 228 constituting a magnetic circuit and a magnet 223 which magnetizes the ferrite members 222A and 222B are shared by the ferrite members 222A and 222B.

The multilayer substrate 225, which comprises electrode structure including two circulators, is comprised. The electrode structure is the same as that of the multilayer substrate 155 described with reference to FIG. 17 in the sixth embodiment of the present invention. However, in this embodiment, a plurality of electrode structures are comprised in the multilayer substrate 225 in accordance with the number (2) of the circulators.

According to the communication circuit module in this embodiment, the plural circulators which operate in the different frequency band are integrated in one module. Therefore, as compared to a case where a plurality of circulators are mounted respectively as a single part, it is less necessary to consider a positional relation with parts provided around it. As a result, the plural circulators can be taken into the communication circuit module while the effective occupied space is reduced. Consequently, integrated small dual band communication circuit module can be implemented. Since each circulator shares a set of yoke materials 224 and 228 and one magnet 223, the number of parts can be reduced as compared to the case when these are prepared separately. Consequently, there can be provided a dual band communication circuit module in which the plural circulators are comprised and which is excellent in view of mass production property and costs.

According to the present invention described above, there can be provided a non-reciprocal circuit element which implements miniaturization and mass production without deteriorating the electric characteristic. In addition, there can be provided a communication circuit module provided with the non-reciprocal circuit element in which effective occupied space is reduced without deteriorating the electric characteristic. Furthermore, there can be provided a communication circuit module in which heat generated by the mounted parts can be released by a simple method without being subjected to various restraints in the material or structure of the multilayer substrate.

Although the preferred embodiments of the present invention has been described in detail, it is clearly understood that combinations and arrangements of the parts in the preferred embodiments can be changed within the spirit and scope of the present invention to be claimed hereinafter.

What is claimed is:

1. A non-reciprocal circuit element comprising:
at least three center electrodes superposed and arranged so as to intersect with each other;
a capacitor connected to one end of the center electrodes in parallel;
earth electrodes connected to another ends of the center electrodes and arranged between the center electrodes at least one by one;
electrical isolation layers arranged between the center electrodes and the earth electrodes;
a ferrite member arranged adjacent to the center electrodes;
a magnet for applying a direct current magnetic field to the ferrite member; and
a yoke material combined with the ferrite member and the magnet to constitute a magnetic circuit.

2. A non-reciprocal circuit element according to claim 1, wherein the center electrodes, the earth electrodes and the electrical isolation layers constitute a multilayer substrate.

3. A non-reciprocal circuit element according to claim 2, wherein the capacitor is formed in the multilayer substrate.

4. A non-reciprocal circuit element according to claim 3, wherein the capacitor comprises a pair of counter electrodes arranged oppositely and a dielectric layer sandwiched between the counter electrodes and the capacitor is integrated with the multilayer substrate, and
another earth electrode is provided between other layers of the multilayer substrate except for the dielectric layer and the electrical isolation layer and the another earth electrode is connected to the another ends of the center electrodes.

5. A non-reciprocal circuit element according to claim 2, further comprising a surface electrode exposed on a surface of the multilayer substrate and connected to the another ends of the center electrodes, wherein the yoke material is formed of an electroconductive material and the yoke material abuts on the surface electrode to be connected.

6. A non-reciprocal circuit element comprising:
at least three center electrodes superposed and arranged so as to intersect with each other;
electrical isolation layers arranged between the center electrodes;
a capacitor connected to one end of the center electrodes in parallel;
a ferrite member arranged adjacent to the center electrodes;
a magnet for applying a direct current magnetic field to the ferrite member;
a yoke material combined with the ferrite member and the magnet to constitute a magnetic circuit;
a multilayer substrate comprising the center electrodes and the electrical isolation layers; and
via hole conductors provided in the multilayer substrate and connecting layers at connection points in the multilayer substrate comprising connection points of both ends of the center electrodes,
wherein the via hole conductor connected to another ends of the center electrodes has electric resistance lower than that of the another via hole conductors.

7. A non-reciprocal circuit element according to claim 6, wherein the via hole conductor connected to the another ends of the center electrodes has a via total sectional area larger than that of the another via hole conductors.

8. A non-reciprocal circuit element according to claim 6, wherein the capacitor is formed in the multilayer substrate.

9. A non-reciprocal circuit element according to claim 8, wherein the capacitor comprises a pair of counter electrodes disposed oppositely, a dielectric layer sandwiched between the counter electrodes and the capacitor is integrated with the multilayer substrate, and
an earth electrode is provided between layers of the multilayer substrate and this earth electrode is connected to the another ends of the center electrodes.

10. A non-reciprocal circuit element according to claim 6, further comprising a surface electrode exposed on a surface of the multilayer substrate and connected to the another ends of the center electrodes, wherein the yoke material is formed of an electroconductive material and the yoke material abuts on the surface electrode to be connected.

11. A non-reciprocal circuit element comprising:
at least three center electrodes superposed and arranged so as to intersect with each other;
a capacitor connected to respective one end of the center electrodes in parallel;
electrical isolation layers arranged between the center electrodes, respectively;
a ferrite member arranged adjacent to the center electrodes;
a magnet for applying a direct current magnetic field to the ferrite member;
a yoke material combined with the ferrite member and the magnet to constitute a magnetic circuit;
a multilayer substrate comprising the center electrodes and the electrical isolation layers; and
an earth electrode provided on the end surface of the multilayer substrate,
wherein another ends of the center electrodes are respectively extended to the end surface of the multilayer substrate to be connected to the earth electrode.

12. A non-reciprocal circuit element according to claim 11, wherein the capacitor is formed in the multilayer substrate.

13. A non-reciprocal circuit element according to claim 12, wherein the capacitor comprises a pair of counter electrodes arranged oppositely and a dielectric layer sandwiched between the counter electrodes and the capacitor is integrated with the multilayer substrate, and
another earth electrode is provided between other layers of the multilayer substrate except for the dielectric layer and the electrical isolation layer and the another earth electrode is connected to the another ends of the center electrodes.

14. A non-reciprocal circuit element comprising:
at least three center electrodes superposed and arranged so as to intersect with each other;
electrical isolation layers arranged between the center electrodes;
a capacitor connected to one end of the center electrodes in parallel;
a ferrite member arranged adjacent to the center electrodes;
a magnet for applying a direct current magnetic field to the ferrite member;
a yoke material combined with the ferrite member and the magnet to constitute a magnetic circuit; and
a multilayer substrate comprising the center electrodes and the electrical isolation layers,
wherein the capacitor comprises a pair of counter electrodes arranged oppositely and a dielectric layer sandwiched between the counter electrodes and the capacitor is integrated with the multilayer substrate, and one side of the counter electrode is connected to one end of the center electrode and the another counter electrode is exposed on a surface of the multilayer substrate.

15. A non-reciprocal circuit element according to claim 14, wherein the dielectric layer is made of a material having dielectric constant higher than that of the electrical isolation layer.

16. A non-reciprocal circuit element according to claim 14, wherein an earth electrode is provided between other layers of the multilayer substrate except for the dielectric layer and this earth electrode is connected to the another ends of the center electrodes.

17. A communication circuit module comprising a non-reciprocal circuit element, wherein the non-reciprocal circuit element comprises;
at least three center electrodes superposed and arranged so as to intersect with each other;
a capacitor connected to one end of the center electrodes in parallel;
electrical isolation layers arranged between the center electrodes;
a ferrite member arranged adjacent to the center electrodes;
a magnet for applying a direct current magnetic field to the ferrite member;
a yoke material combined with the ferrite member and the magnet to constitute a magnetic circuit; and
a multilayer substrate comprising the center electrodes and the electrical isolation layers, and
the multilayer substrate functions as a main module component.

18. A communication circuit module according to claim 17, further comprising earth electrodes connected to the another ends of the center electrodes and disposed between the center electrodes at least one by one, wherein the electrical isolation layers are arranged between the center electrodes and the earth electrodes and the multilayer substrate comprises the center electrodes, the earth electrodes and the electrical isolation layers.

19. A communication circuit module according to claim 17, wherein the capacitor is formed in the multilayer substrate.

20. A communication circuit module according to claim 18, wherein the capacitor comprises a pair of counter electrodes arranged oppositely and a dielectric layer sandwiched between the counter electrodes and the capacitor is integrated with the multilayer substrate, and
another earth electrode is provided between other layers of the multilayer substrate except for the dielectric layer and the electrical isolation layer and the another earth electrode is connected to the another ends of the center electrodes.

21. A communication circuit module according to claim 18, further comprising a surface electrode exposed on a surface of the multilayer substrate and connected to the another ends of the center electrodes, wherein the yoke material is formed of an electroconductive material and the yoke material abuts on the surface electrode to be connected.

22. A communication circuit module according to claim 17 further comprising:
via hole conductors provided in the multilayer substrate and connecting layers at connection points in the multilayer substrate comprising connection points of both ends of the center electrodes,
wherein the via hole conductor connected to the another ends of the center electrodes has electric resistance lower than that of the another via hole conductors.

23. A communication circuit module according to claim 22, wherein the via hole conductors connected to the another ends of the center electrodes has a via total sectional area larger than that of the another via hole conductors.

24. A communication circuit module according to claim 19, wherein
the capacitor comprises a pair of counter electrodes arranged oppositely and a dielectric layer sandwiched between the counter electrodes and the capacitor is integrated with the multilayer substrate, and
one side of the counter electrode is connected to one end of the center electrode and the another counter electrode is exposed on a surface of the multilayer substrate.

25. A non-reciprocal circuit element according to claim 24, wherein the dielectric layer is made of a material having dielectric constant higher than that of the electrical isolation layer.

26. A communication circuit module according to claim 24, wherein another earth electrode is provided between other layers of the multilayer substrate except for the dielectric layer and the electrical isolation layer and the another earth electrode is connected to the another ends of the center electrodes.

27. A communication circuit module according to claim 17, wherein electrode patterns comprising the center electrodes are provided in the multilayer substrate and
an electrode thickness of the center electrode is larger than an average value of an electrode thickness of the another electrode pattern provided in the multilayer substrate.

28. A communication circuit module according to claim 17, wherein parts are mounted on the multilayer substrate and at least one of the parts abuts on the yoke material.

29. A communication circuit module according to claim 28, wherein the part to abut on the yoke material is a power amplifier.

30. A communication circuit module according to claim 17, having a plurality of the non-reciprocal circuit elements.

31. A communication circuit module according to claim 30, wherein one of the yoke material is provided for the plurality of non-reciprocal circuit elements.

32. A communication circuit module according to claim 30, wherein one of the magnet is provided for the plurality of non-reciprocal circuit elements.

33. A communication circuit module according to claim 17, wherein a cavity for housing one part or all of the ferrite member and the yoke material is provided in the multilayer substrate in such a manner that the surface of the members does not protrude from the multilayer substrate.

34. A communication circuit module according to claim 17, wherein a cavity for housing one part or all of the magnet and the yoke material is provided in the multilayer substrate in such a manner that the surface of the members does not protrude from the multilayer substrate.
